(19) United States
(12) Patent Application Publication
(10) Pub. No.: US 2023/0324823 A1
(43) Pub. Date: Oct. 12, 2023

(54) RESIN PARTICLES, TONER, DEVELOPER, TONER HOUSING UNIT, IMAGE FORMING APPARATUS, AND METHOD OF FORMING IMAGE

(71) Applicants: Toshihiko SUGIYAMA, Shizuoka (JP); Tsuneyasu NAGATOMO, Shizuoka (JP); Junichi WATANABE, Shizuoka (JP); Kazuoki FUWA, Shizuoka (JP); Yuka MIZOGUCHI, Shizuoka (JP)

(72) Inventors: Toshihiko SUGIYAMA, Shizuoka (JP); Tsuneyasu NAGATOMO, Shizuoka (JP); Junichi WATANABE, Shizuoka (JP); Kazuoki FUWA, Shizuoka (JP); Yuka MIZOGUCHI, Shizuoka (JP)

(73) Assignee: Ricoh Company, Ltd., Tokyo (JP)

(21) Appl. No.: 18/183,282

(22) Filed: Mar. 14, 2023

(30) Foreign Application Priority Data
Mar. 17, 2022 (JP) 2022-043091
Jun. 29, 2022 (JP) 2022-104675
Nov. 21, 2022 (JP) 2022-185762

(51) Int. Cl. G03G 9/09; G03G 15/08; G03G 9/097

(52) U.S. Cl. CPC G03G 9/09733; G03G 9/0906; G03G 15/08

(57) ABSTRACT

Resin particles that can exhibit high degree of coloring and have high charge stability are provided. Resin particles include a base particle including a binder resin and a pigment having an isoindoline skeleton, wherein a longitudinal diameter of the base particle is L, an overlapped area where the cross-section of the base particle overlaps with a passage of circle C when a center of the circle C with a radius (L/10) moves along a contour of the cross-section of the base particle is defined as a surface layer of the resin particle, wherein the pigment having isoindoline skeleton present on the surface layer of the base particle relative to an entire pigment having isoindoline skeleton present on the cross-section of the base particle in a cross-sectional image of the resin particle is less than 30%, and wherein a gel fraction of the base particle is 20% by mass or more.

### CROSS-REFERENCE TO RELATED APPLICATION

The present application claims priority under 35 U.S.C. § 119 to Japanese Pat. Application No. 2022-043091, filed Mar. 17, 2022, No. 2022-104675, filed Jun. 29, 2022, and No. 2022-185762, filed Nov. 21, 2022, the contents of which are incorporated herein by reference in their entirety.

### BACKGROUND OF THE INVENTION

### 1. Field of the Invention

The disclosures herein relate to resin particles, a toner, a developer, a toner housing unit, an image forming apparatus, and a method of forming images.

### 2. Description of the Related Art

Resin particles are widely used as toner of image forming apparatus such as multi-functional printers (MFP) and printers in various places such as offices. In order to reduce the impact on the environment, the following are being considered for toner: reducing power consumption by improving the low-temperature fixability of the toner itself and reducing energy consumption during manufacturing.

As methods to improve the low-temperature fixability of toners, methods such as reducing the glass transition temperature and softening point of resins and adding crystalline resins are widely known. Moreover, the demand for high-image quality comparable to that of offset printing in terms of, for example, fine lines and color characteristics is also increasing. In color image forming based on full-color electrophotography, all colors are typically reproduced by overlapping the layers of the three primary color toners, i.e., yellow, magenta and cyan toner, or of four-color toners including the three primary color toners and black toner.

As a color toner used in full-color electrophotography, an electrophotographic toner is disclosed in which a mixture of a toner masterbatch containing a resin, a coloring agent, and a plasticizer mixed with a binder resin is dispersed and emulsified in an aqueous medium to produce a resin emulsion, and the resulting emulsified particles in the resin emulsion are agglomerated and coalesced to suppress the agglomeration of pigments and enhance the dispersibility of pigments (e.g., Japanese Patent Application Laid-Open No. 2008-70466).

### SUMMARY OF THE INVENTION

### Problems to Be Solved by Invention

However, in the toner disclosed in Japanese Patent Application Laid-Open No. 2008-70466, when the masterbatch is dissolved in an organic solvent in a wet granulation method such as emulsion polymerization or suspension polymerization, the dispersibility of the pigment is low, so that the coloring agent tends to be unevenly distributed on the surface of the toner-based particles in the process of manufacturing the toner. Therefore, there is a problem that the coloring agent tends to agglomerate on the surface of the toner-based particles, resulting in poor color reproducibility. In addition, there is a problem that the charge stability of the toner decreases because the variation in the resistance value of the resin contained in the toner increases.

One aspect of the present invention can provide resin particles that exhibit a high degree of coloring and also have high charge stability.

### Means to Solve Problems

One aspect of the resin particles according to the present invention is to provide resin particles including a base particle including a binder resin and a pigment having isoindoline skeleton, wherein a longitudinal diameter of the base particle is L, an overlapped area where the cross-section of the base particle overlaps with a passage of circle C when a center of the circle C with a radius (L/10) moves along a contour of the cross-section of the base particle is defined as a surface layer of the resin particle, wherein the pigment having an isoindoline skeleton present on the surface layer of the base particle relative to an entire pigment having an isoindoline skeleton present on the cross-section of the base particle in a cross-sectional image of the resin particle is less than 30%, and wherein a gel fraction of the base particle is 20% by mass or more.

### Effect of Invention

One aspect of the present invention can provide resin particles that exhibit a high degree of coloring and also have high charge stability.

### BRIEF DESCRIPTION OF THE DRAWINGS

FIG. 1 is a diagram illustrating an example of a cross-sectional image of a resin particle according to an embodiment;

FIG. 2 is a schematic diagram illustrating an example of an image forming apparatus according to an embodiment;

FIG. 3 is a schematic diagram illustrating another example of an image forming apparatus according to an embodiment;

FIG. 4 is a schematic diagram illustrating another example of an image forming apparatus according to an embodiment;

FIG. 5 is a partially enlarged view of the image forming apparatus of FIG. 4; and

FIG. 6 is a schematic diagram illustrating an example of a process cartridge according to an embodiment.

### DESCRIPTION OF THE PREFERRED EMBODIMENTS

Embodiments of the present invention will be described in detail below. Embodiments are not limited by the following descriptions, and may be appropriately changed to the extent that the changes do not deviate from the gist of the invention. In addition, “to” denoting a numerical range in the specification means, unless otherwise stated, that the numerical values listed before and after the number are included as lower and upper limits.

### Resin Particles

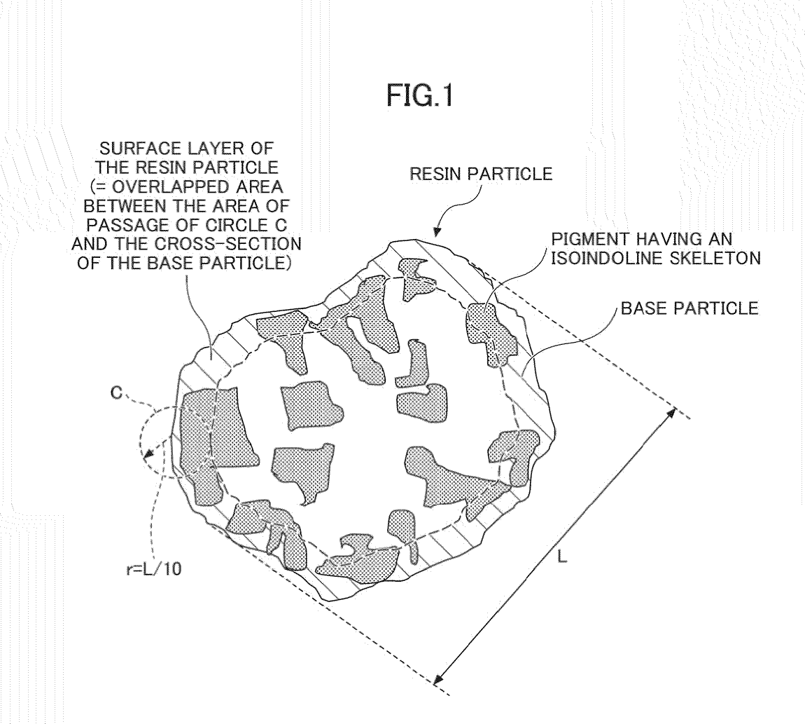

The resin particles according to one embodiment will be described. The resin particles according to one embodiment contain a base particle including a binder resin and a pigment having an isoindoline skeleton. As illustrated in FIG. 1, a longitudinal diameter of the base particle is L, an overlapped area where the cross-section of the base particle overlaps with a passage of circle C when a center of the circle C with a radius (L/10) moves along a contour of the cross-section of the base particle is defined as a surface layer of the resin particle. The pigment having isoindoline skeleton present on the surface layer of the base particle relative to an entire pigment having isoindoline skeleton present on the cross-section of the base particle in a cross-sectional image of the resin particle is less than 30%. A gel fraction of the base particle is 20% by mass or more.

As a result of diligent research, the inventors of the present invention found that resin particles containing pigments and coloring agents generally cause the pigments and coloring agents to be unevenly distributed in the resin particles. Therefore, in addition to the color adjustment function of the coloring agent not being fully realized, variations in the resistance of the base particles due to the pigment bias occur. The inventors of the present invention focused on the method of calculating the percentage of pigment having isoindoline skeleton present on the surface layer of the base particle relative to an entire pigment having isoindoline skeleton present on the cross-section of the base particle in a cross-sectional image of the resin particle, and the gel fraction of the base particles. The longitudinal diameter of the base particle is L, the overlapped area where the cross-section of the base particle overlaps with the passage of circle C when the center of the circle C with a radius (L/10) moves along the contour of the cross-section of the base particle is defined as the surface layer of the resin particle. The pigment having an isoindoline skeleton present on the surface layer of the base particle relative to the entire pigment having an isoindoline skeleton present on the cross-section of the base particle in the cross-sectional image of the resin particle is less than 30%. The gel fraction of the base particle is 20% by mass or more. The inventors of the present invention have found that the resin particles having the above configuration can prevent the lack of coloring and the reduction of charge stability caused by the uneven distribution of the pigment having an isoindoline skeleton.

The percentage of the pigment having an isoindoline skeleton present on the surface layer of the resin particles is preferably less than 25%, more preferably less than 20%, and even more preferably less than 15%.

The gel fraction of the resin particles is preferably 24% by mass or more, more preferably 25% by mass or more, and even more preferably 26% by mass or more.

A method of measuring the amount of a coloring agent such as a pigment having an isoindoline skeleton present on the surface of the base particles (surface of the resin particles) in the cross-sectional image of the resin particles will be described. First, a method of obtaining a cross-sectional image of the resin particles will be described. After embedding the resin particles in an epoxy resin, a microtome is used to prepare a thin slice with a thickness of 0.1 µm to 0.2 µm, and a cross-sectional image is obtained by a microscope such as an optical microscope, a fluorescence microscope, a SEM, a TEM, or the like. In this case, the cross-section of the base particles can be obtained by a microtome or an ion milling. Here is an example of the conditions.
_{•}Microtome: Diamond knife (45° blade angle)
•Optical microscope: Observed in transmission image
•Fluorescence microscope: Observed in fluorescence image
_{•}TEM: Transmission image observed at 50 to 200 kV acceleration voltage
_{•}SEM: Observed at 0.8 to 2 kV acceleration voltage
•Ion milling: Cross-section prepared while cooling

After obtaining the cross-sectional image of the base particles, the amount of pigment having an isoindoline skeleton in the cross-section of the base particles is measured by the following procedure. The cross-sectional image of the base particles is taken at 10,000 times magnification and the above TEM conditions may be adopted.

Step 1. Ten resin particles with an average volume particle size of Dv±1 µm are extracted.

Step 2. Using the Image-Pro Premier image analysis software, the contours of resin particles are extracted from the cross-sectional image of the resin particles. Step 3. The contours of coloring agents are also extracted from the contrast as in step 2.

Step 4. A center of circle C with a radius (L/10) is moved along the contour of a cross-section of the resin particle when the longitudinal diameter of base particle is L.

Step 5. The overlapped area where the cross-section of the resin particle overlaps with the passing area where the circle C passed is defined as a surface layer of the resin particle.

Step 6. The area of all cross-sections of pigments having an isoindoline skeleton present on the cross-sectional image of the base particle is calculated. Step 7. The Steps 2 to 6 are repeated to obtain an average value for ten base particles.

### (Method of Measuring Gel Fraction)

The degree of crosslinking of the base particles is usually correlated with the gel fraction, and in the present embodiment, it is preferable to measure the gel fraction of the base particles by the following method.

First, about 0.3 g of dried resin fine particles is prepared as a sample, which is then put into 30 g of an organic solvent and stirred for 60 minutes. Then, the mixture is centrifugated at a rotation speed of 10,000 rpm for 5 minutes, followed by removing the supernatant from which the solvent is extracted. Then, the undissolved substance in the organic solvent is dried in a vacuum dryer. The weight of dried substance is measured, and the gel fraction (% by mass) is calculated by the following equation. It should be noted that the organic solvent, for example, tetrahydrofuran or the like may be used.

Gel fraction (% by mass) = (weight of the group of monodispersed resin particles undissolved in the organic solvent/weight of the group of monodispersed resin particles to be used for the sample) × 100

In order to obtain the required degree of crosslinking, the gel fraction of the base particles needs to be 20% by mass or more, preferably 24% by mass or more, more preferably 25% by mass or more, and even more preferably 26% by mass or more, as described above. When the gel fraction is 20% by mass or more, the degree of crosslinking can be maintained high, so that the viscoelasticity of the binder resin is suppressed from decreasing, and the dispersibility of pigments having an isoindoline skeleton can be maintained.

As described above, the resin particles in one embodiment contain a binder resin and a pigment having an isoindoline skeleton, and may contain other components as necessary.

### [Binder Resin]

The binder resin used in the present embodiment can be any resin that is soluble in organic solvents and insoluble or hardly soluble in water. Examples of binder resins include polyester resin, polystyrene resin, polyvinyl chloride resin, polyvinyl acetate resin, polyethylene resin, polyurethane resin, polyamide resin, epoxy resin, polyethylene terephthalate (PET), styrene-acrylic acid copolymer, polymethacrylate resin, polymethyl acrylate (PMA), polyacrylate, polyacrylonitrile (PAN), paraffin wax, and the like. These may be used alone or in combination. Among these, polyester resin is preferably used in terms of excellent fixability.

### (Polyester Resin)

When a resin used for toners for electrostatic latent images in electrophotography, excellent fixability can be obtained by using a resin having a polyester skeleton. Although there are polyester resins and block polymers of polyester and resins having other skeletons as resins having a polyester skeleton, it is preferable to use a polyester resin because the resulting colored resin particles are highly uniform and desirable.

Examples of polyester resins include ring-opening polymers of lactones, condensation polymers of hydroxycarboxylic acids, polycondensates of polyols and polycarboxylic acids, and polycondensates of polyols and polycarboxylic acids are preferably used from the viewpoint of design flexibility.

The weight-average molecular weight (Mw) of polyester resins is usually 1,000 to 30,000, preferably 3,000 to 15,000, and even more preferably 5,000 to 12,000. If the weight-average molecular weight (Mw) is 1,000 or more, the decrease in heat-resistant storage stability can be suppressed. If the weight-average molecular weight (Mw) is 30,000 or less, the increase in viscoelasticity of resin particles during melting can be suppressed, and the decrease in low-temperature fixability of resin particles can be suppressed.

The glass transition temperature (Tg) of the polyester resin is preferably 35° C. to 80° C., more preferably 40° C. to 70° C., and even more preferably 45° C. to 65° C. When the glass transition temperature (Tg) is 35° C. or higher, it is possible to prevent the resulting resin particles from deforming when placed in a high-temperature environment, such as under sunlight, or from sticking together so that the resin particles no longer behave as original resin particles. When the glass transition temperature (Tg) is 80° C. or lower, deterioration in fixability can be suppressed when the resin particles are used as toners that are for electrostatic latent image developer.

### (Polyol)

Examples of polyols (1) include diol (1-1) and trivalent or higher polyols (1-2). Polyol is preferably diol (1-1) alone or a mixture of diol (1-1) and a small amount of trivalent or higher polyols (1-2).

Examples of diol (1-1) include alkylene glycol (ethylene glycol, 1,2-propylene glycol, 1,3-propylene glycol, 1,4-butanediol, 1,6-hexanediol, and the like); alkylene ether glycol (diethylene glycol, triethylene glycol, dipropylene glycol, polyethylene glycol, polypropylene glycol, polytetramethylene ether glycol, neopentyl glycol, and the like); alicyclic diol (1,4-cyclohexanedimethanol, hydrogenated bisphenol A, and the like); bisphenols (bisphenol A, bisphenol F, bisphenol S, and the like); alkylene oxide (ethylene oxide, propylene oxide, butylene oxide, and the like) adducts of the above alicyclic diols; 4,4′-dihydroxybiphenyls such as 3,3′-difluoro-4,4′-dihydroxybiphenyls; bis(3-fluoro-4-hydroxyphenyl) alkanes such as bis(3-fluoro hydroxyphenyl)methane, 1-phenyl-1,1-bis(3-fluoro-4 hydroxyphenyl)ethane, 2,2-bis (3-fluoro-4 hydroxyphenyl)propane, 2,2-bis(3,5-difluoro -4-hydroxyphenyl)propane (also known as: tetrafluorobisphenol A), 2,2-bis(3-hydroxyphenyl)-1,1,1,3,3,3-hexafluoropropane; bis(4-hydroxyphenyl)ethers such as bis(3-fluoro-4-hydroxyphenyl)ethers; and alkylene oxide (ethylene oxide, propylene oxide, butylene oxide, and the like) adducts of the above bisphenols. Among these, alkylene glycol having a carbon number of 2 to 12 and alkylene oxide adducts of bisphenols are preferably used, and alkylene oxide adducts of bisphenols and their combination with alkylene glycol having a carbon number of 2 to 12 are particularly preferably used.

Examples of trivalent or higher polyol (1-2) include polyaliphatic alcohols with a valence of from three to eight or higher than eight (glycerin, trimethylolethane, trimethylolpropane, pentaerythritol, sorbitol, and the like); trivalent or higher phenols (tris phenol PA, phenol novolac, cresol novolac, and the like); alkylene oxide adducts of trivalent or higher polyphenols.

### (Polycarboxylic Acid)

Examples of polycarboxylic acids (2) include dicarboxylic acid (2-1) and trivalent or higher polycarboxylic acid (2-2). Polycarboxylic acid (2) is preferably dicarboxylic acid (2-1) alone or a mixture of dicarboxylic acid (2-1) and a small amount of trivalent or higher polycarboxylic acid (2-2).

Examples of dicarboxylic acid (2-1) include alkylenedicarboxylic acid (succinic acid, adipic acid, sebacic acid, and the like); alkenylenedicarboxylic acid (maleic acid, fumaric acid, and the like); aromatic dicarboxylic acids (phthalic acid, isophthalic acid, terephthalic acid, naphthalenedicarboxylic acid, and the like), 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethyl isophthalic acid, 2,2-bis(4-carboxyphenyl) hexafluoropropane, 2,2-bis(3-carboxyphenyl) hexafluoropropane, 2,2′-bis(trifluoromethyl)-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid, hexafluoroisopropylidene diphthalic anhydride, and modified purified rosins, and the like. The modified purified rosins are preferably modified with acrylic acid, fumaric acid, and maleic acid. Among these, alkenylenedicarboxylic acid having a carbon number of 4 to 20 and aromatic dicarboxylic acid having a carbon number of 8 to 20 are preferably used.

Examples of trivalent or higher polycarboxylic acid (2-2) include aromatic polycarboxylic acid having a carbon number of 9 to 20 (trimellitic acid, pyromellitic acid, and the like).

The polycarboxylic acid (2) may be reacted with the polyol (1) using an acid anhydride or a lower alkyl ester (methyl ester, ethyl ester, isopropyl ester, and the like) of the above.

The ratio of the polyol to the polycarboxylic acid is usually 2/1 to 1/2, preferably 1.5/1 to 1/1.5, even more preferably 1.3/1 to 1/1.3, as the equivalence ratio of the hydroxyl group [OH] to the carboxyl group [COOH] ([OH]/[COOH]).

### [Pigments Having Isoindoline Skeletons]

Pigments having an isoindoline skeleton (isoindoline pigments) are used as coloring agents for yellow pigments. As isoindoline pigments, C. I. Pig. Y -185 or the like having a bright yellow color can be used. Isoindoline-based pigments have excellent weather resistance and high coloring among azo-based pigments because of their skeletons. Isoindoline-based pigments also have good secondary color development because the pigments have high permeability in the visible range of the long wavelength side of 500 nm to 700 nm.

The content of the coloring agent is usually 1% by mass to 15% by mass and preferably 3% by mass to 10% by mass with respect to the resin particles.

The resin particles in one embodiment can be used as a masterbatch by kneading the above binder resin and the isoindoline-based pigments.

For kneading, a general kneader such as a biaxial extrusion kneader, a three-roller, a lab blast mill, and the like can be used.

The kneading is preferably performed while heating. The heating conditions at this time can be set appropriately.

In the kneading treatment, an internal additive agent may be added in addition to the binder resin and the isoindoline-based pigment.

By using a masterbatch, when the isoindoline-based pigment is dispersed in the oil phase, the agglomeration of the isoindoline-based pigment by reducing an impact and the dispersibility of the isoindoline-based pigment is improved, so that the resin particles in one embodiment can be a yellow toner having excellent coloring and charge stability.

### [Reactive Precursor]

The resin particles according to one embodiment can contain polyethylene terephthalate (PET), polybutylene terephthalate (PBT), or a reactive precursor (prepolymer), and the like. The reactive precursor includes a polyester resin (also called polyester resin (A)) having a group that can react with an active hydrogen group.

Examples of groups that can react with active hydrogen groups include isocyanate groups, epoxy groups, carboxylic acids, acid chloride groups, and the like. Among these, isocyanate groups are preferable in that urethane or urea bonds can be introduced into the amorphous polyester resin. Since the urea bonds have polar groups, the urea bonds are easily adsorbed onto the pigments, allowing a high degree of dispersion of the pigments.

The reactive precursors may have branched structures imparted by at least one of trivalent or higher alcohols and trivalent or higher carboxylic acids.

Examples of polyester resins containing isocyanate groups include reaction products of polyisocyanates with polyester resins having active hydrogen groups.

The polyester resins having active hydrogen groups are obtained, for example, by polycondensation of a diol, a dicarboxylic acid, and at least one of a trivalent or higher alcohol and a trivalent or higher carboxylic acid.

Trivalent or higher alcohols and trivalent or higher carboxylic acids impart branched structures to polyester resins containing isocyanate groups.

Examples of diols include aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, 1,12-dodecanediol, and the like; diols having oxyalkylene groups such as diethylene glycol, triethylene glycol, dipropylene glycol, polyethylene glycol, polypropylene glycol, polytetramethylene glycol, and the like; alicyclic diols such as 1,4-cyclohexane dimethanol, hydrogenated bisphenol A, and the like; alicyclic diols with alkylene oxides such as ethylene oxide, propylene oxide, butylene oxide added, and the like; bisphenols such as bisphenol A, bisphenol F, and bisphenol S; alkylene oxide adducts of bisphenols such as those in which alkylene oxides such as ethylene oxide, propylene oxide, butylene oxide, and the like are added to bisphenols. Among these, from the viewpoint of controlling the glass transition point of polyester resin (A) to 20° C. or lower, aliphatic diols having a carbon number of 3 to 10 such as 1,2-propylene glycol, 1,3-propylene glycol, 1,4-butanediol, 2-methyl-1,3-propanediol, 1,5-pentanediol, 3-methyl-1,5-pentanediol, and the like are preferably used, and 50% by mol or more of the alcohol component in the resin is more preferably used. These diols may be used alone or in combination of two or more.

It is desirable that the polyester resin (A) is an amorphous resin and that the steric hindrance of the resin chain reduces the melt viscosity at the time of fixing, making it easier to develop low-temperature fixability. For this reason, it is preferable that the main chain of the aliphatic diol has a structure represented by general formula (1) below.

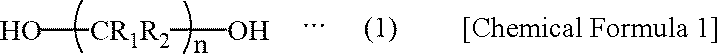

[In the formula, R₁ and R₂ each independently represent a hydrogen atom or an alkyl group having a carbon number of 1 to 3, and n represents an odd number of 3 to 9. In the n repeating units, R₁ and R₂ may be the same or different from each other.]

Here, the main chain of an aliphatic diol is a carbon chain connected between the two hydroxyl groups of the aliphatic diol in the shortest carbon number. When the carbon number of the main chain is an odd number, it is preferable because the crystallinity decreases due to the Odd-Even effects. Also, when the side chain has at least 1 or more alkyl groups having a carbon number of 1 to 3, it is more preferable because the interaction energy between the main chain molecules decreases due to stericity.

Examples of dicarboxylic acid include aliphatic dicarboxylic acids such as succinic acid, adipic acid, sebacic acid, dodecanedioic acid, maleic acid, fumaric acid, and the like; aromatic dicarboxylic acids such as phthalic acid, isophthalic acid, terephthalic acid, naphthalenedicarboxylic acid, and the like. These anhydrides, lower (having a carbon number of 1 to 3) alkyl esters and halides may also be used. Among these, from the viewpoint of controlling the glass transition temperature (Tg) of the polyester resin (A) to 20° C. or lower, an aliphatic dicarboxylic acid having a carbon number of 4 to 12 is preferably used, and 50% by mass or more of the carboxylic acid component in the resin is more preferably used. These dicarboxylic acids may be used alone, or two or more may be used in combination.

Examples of trivalent or higher alcohols include trivalent or higher aliphatic alcohols such as glycerin, trimethylolethane, trimethylolpropane, pentaerythritol, sorbitol, and the like; trivalent or higher polyphenols such as 4(4(1,1-bis(p-hydroxyphenyl) ethyl)α,α-dimethylbenzyl)phenol, phenol novolac, cresol novolac, and the like. Examples of trivalent polyphenols include alkylene oxide adducts of trivalent or higher polyphenols such as ethylene oxide, propylene oxide, butylene oxide added, and the like to trivalent or higher polyphenols.

Examples of trivalent or higher carboxylic acids include trivalent or higher aromatic carboxylic acids having a carbon number of 9 to 20 such as trimellitic acid, pyromellitic acid, and the like. These anhydrides, lower (having a carbon number of 1 to 3) alkyl esters and halides may also be used.

Examples of polyisocyanates include diisocyanates, trivalent or higher isocyanates, and the like.

Polyisocyanates are not particularly limited and can be selected as appropriate for their purpose. Examples of polyisocyanates include 1,3-and/or 1,4-phenylenediisocyanate, 2,4- and/or 2,6-tolylene diisocyanate (TDI), crude TDI, 2,4′- and/or 4,4′-diphenylmethane diisocyanate (MDI), crude MDI [Coarse diaminophenylmethane (product of condensation of formaldehyde with aromatic (aniline) or mixtures thereof); phosgenide: polyallyl polyisocyanate (PAPI) in a mixture of diaminodiphenylmethane and a small amount (e.g., 5 to 20% by mass) of polyamines having three or more functional groups]; aromatic diisocyanates such as 1,5-naphthyl diisocyanate, 4,4’,4″-triphenylmethane triisocyanate, m- and p-isocyanatophenyl sulfonyl isocyanate, and the like; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethyl hexamethylene diisocyanate, lysine diisocyanate, 2,6-diisocyanatomethyl caproate, bis(2-isocyanatoethyl) fumarate, bis(2-isocyanatoethyl) carbonate, 2-isocyanatoethyl-2,6-diisocyanatohexanoate; alicyclic diisocyanates such as isophorone diisocyanate (IPDI), dicyclohexylmethane-4,4′-diisocyanate (hydrogenated MDI), cyclohexyl diisocyanate, methylcyclohexyl diisocyanate (hydrogenated TDI), bis(2-isocyanatoethyl)-4-cyclohexene-1,2-dicarboxylate, 2,5-and 2,6-norbornane diisocyanates; aromatic aliphatic diisocyanates such as m- and p-xylylene diisocyanate (XDI), α,α′,α′-tetramethylxylylene diisocyanate (TMXDI); trivalent or higher polyisocyanates such as lysine triisocyanate, diisocyanate denaturation of trivalent or higher alcohol; denaturation of these isocyanates. These may be a mixture of more than two of these. Examples of denatured isocyanates include a urethane group, a carbodiimide group, an allophanate group, a urea group, a burette group, a urethidione group, a ureteimine group, an isocyanurate group, an oxazolidone group-containing denatured product, and the like.

### [Crystalline Polyester Resin]

The resin particles in one embodiment can contain a crystalline polyester resin. The crystalline polyester resin is obtained from a polyvalent alcohol and polyvalent carboxylic acids such as a polycarboxylic anhydride, a polycarboxylic ester, or a derivative thereof. In the present embodiment, the crystalline polyester resin means a product obtained by using a polyvalent alcohol and a polycarboxylic acid such as a polycarboxylic acid, a polycarboxylic anhydride, a polycarboxylic ester, or a derivative thereof, as described above, and a modified polyester resin, such as a prepolymer, and a resin obtained by crosslinking and/or stretching the prepolymer, does not belong to the crystalline polyester resin.

### -Polyvalent Alcohol-

Polyvalent alcohols are not particularly limited and can be appropriately selected according to the purpose. For example, diols and trivalent or higher alcohols can be used.

Examples of the diol include saturated aliphatic diols. The saturated aliphatic diols include linear saturated aliphatic diols and branched saturated aliphatic diols. Among them, linear saturated aliphatic diols are preferably used, and linear saturated aliphatic diols having a carbon number of 2 to 12 are more preferably used. If the saturated aliphatic diol is a branched type, the crystallinity of the crystalline polyester resin may be decreased and the melting point of the crystalline polyester resin may be lowered. If the carbon number of the saturated aliphatic diol is 12 or less, it becomes easy to obtain the material for practical use.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosandecanediol, and the like. Among these, ethylene glycol, 1,4-butanediol, 1,6-hexanediol, 1,8-octanediol, 1,9-nonanediol, 1,10-decanediol, and 1,12-dodecanediol are preferably used because the crystalline polyester resin has high crystallinity and excellent sharp-melt properties.

Examples of trivalent or higher alcohols include glycerin, trimethylolethane, trimethylolpropane, pentaerythritol, and the like. These may be used alone or in combination of two or more.

### -Polyvalent Carboxylic Acid-

Polyvalent carboxylic acids are not particularly limited and can be appropriately selected according to the purpose. For example, divalent carboxylic acids and trivalent or higher carboxylic acids can be used.

Examples of divalent carboxylic acids include saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like; aromatic dicarboxylic acids such as phthalic acid, isophthalic acid, terephthalic acid, naphthalene-2,6-dicarboxylic acid, malonic acid, mesaconic acid, and the like; and the like. In addition, these anhydrides and these lower (having a carbon number of 1 to 3) alkyl esters are also used.

Examples of trivalent or higher carboxylic acids include 1,2,4-benzenetricarboxylic acid, 1,2,5-benzenetricarboxylic acid, 1,2,4-naphthalenetricarboxylic acid, and their anhydrides and their lower (having a carbon number of 1 to 3) alkyl esters. These may be used alone or in combination of two or more.

The crystalline polyester resin is preferably composed of a linear saturated aliphatic dicarboxylic acid having a carbon number of 4 to 12 and a linear saturated aliphatic diol having a carbon number of 2 to 12. Such structure enables an excellent low-temperature fixability to be exerted because of the high crystallinity and excellent sharp-melt properties.

In addition, methods for controlling the crystallinity and softening point of crystalline polyester resins include designing and using non-linear polyesters or the like that undergo condensation polymerization by adding trivalent or higher polyvalent alcohol such as glycerin to the alcohol component or trivalent or higher polyvalent carboxylic acid such as trimellitic anhydride to the acid component during polyester synthesis.

The molecular structure of crystalline polyester resins can be confirmed by NMR measurements in solutions and solids, as well as X-ray diffraction, GC/MS, LC/MS, IR measurements, and the like. However, in the infrared absorption spectra, examples can be taken that have absorption based on the δCH (out-of-plane bending vibration) of olefins at 965±10cm⁻¹ or 990±10cm⁻¹.

In terms of molecular weight, those with a sharp molecular weight distribution and a low molecular weight are excellent in low-temperature fixability, while many components with a low molecular weight deteriorate heat-resistant storage. From this point of view, it is preferable that the molecular weight distribution by GPC of the soluble part of o-dichlorobenzene has a peak position in the range of 3.5 to 4.0 on the molecular weight distribution map with log (M) on the horizontal axis and % by mass on the vertical axis, a peak width at half maximum of 1.5 or less, a weight-average molecular weight (Mw) of 3,000 to 30,000, a number-average molecular weight (Mn) of 1,000 to 10,000, and a weight-average molecular weight (Mw) to number-average molecular weight (Mn) ratio Mw/Mn of 1 to 10. Furthermore, it is more preferable that the weight-average molecular weight (Mw) is 5,000 to 15,000, the number-average molecular weight (Mn) is 2,000 to 10,000, and the ratio of Mw/Mn is 1 to 5.

The acid value of the crystalline polymer is preferably 5 mgKOH/g or more in order to achieve the desired low-temperature fixability in terms of the affinity between paper and resin. For the preparation of fine particles by the phase transfer emulsification method, the acid value of the crystalline polyester resin is more preferably 7 mgKOH/g or more. In order to improve the hot offsetting property, the acid value of the crystalline polyester resin is preferably 45 mgKOH/g or less.

In addition, the hydroxyl value of the crystalline polyester resin is preferably 0 mgKOH/g to 50 mgKOH/g and more preferably 5 mgKOH/g to 50 mgKOH/g in order to achieve the predetermined low-temperature fixability and to achieve good charging properties.

### [Other Components]

The resin particles of one embodiment may contain other components. Examples of other components include agglomerating agents, release agents (wax), external additives, cleanability improver, and the like.

### (Agglomerating Agents)

The dispersibility of the isoindoline-based pigment can be controlled by the type of agglomerating agents added in the agglomerating step of the method of producing resin particles in one embodiment described later and the method of introducing the isoindoline-based pigment. The dispersibility of the isoindoline-based pigment contained in the resin particles in one embodiment depends on the viscosity in the binder resin and is proportional to the ratio of the metal salt contained in the agglomerated salt such as magnesium to the carboxyl group contained in the polyester resin in the resin particles. When the ratio of the metal salt to the carboxyl group is high, the viscoelasticity of the resin particles increases and the dispersibility of the isoindoline-based pigment increases. The reason for this may be that the carboxyl group chelates with magnesium ion, which is a polyvalent metal ion, to form a metal crosslinking, which increases the density of the crosslinking.

The agglomerating agent preferably contains monovalent or higher metal salt from the viewpoint of ensuring a sufficient density of the crosslinking. The monovalent or higher metal salt contained in the agglomerating agent is preferably a divalent metal salt and more preferably a trivalent metal salt.

A common agglomerating agent can be used as the agglomerating agent. Examples of the agglomerating agents include metal salts of monovalent metals such as sodium, potassium, and the like; divalent metal salts such as calcium, magnesium, and the like; and trivalent metal salts such as iron, aluminum, and the like. An agglomerating agent may be used alone, or two or more agglomerating agents may be used in combination.

### (Wax)

The wax is not particularly limited and can be selected appropriately according to the purpose, but a release agent with a low melting point of 50° C. to 120° C. is preferably used. When the release agent having low-temperature melting point is dispersed with a binder resin, the release agent effectively acts between fixing rollers and the interfaces of the resin particles, thereby providing excellent hot offset even without oil (no release agent like oil is applied to the fixing roller).

The waxes include, for example, natural waxes including botanical waxes such as carnauba wax, cotton wax, japan wax, and rice wax; animal waxes such as beeswax, and lanolin; mineral-based waxes such as ozocerite, and ceresin; and petroleum waxes such as paraffin, microcrystalline, and petrolatum. In addition to these natural waxes, synthetic hydrocarbon waxes such as Fischer-Tropsch waxes and polyethylene waxes; synthetic waxes such as esters, ketones, ethers, and the like are also included. Furthermore, aliphatic acid amides such as 12-hydroxystearic acid amide, amide stearate, phthalimide anhydride, or chlorinated hydrocarbons; homopolymers or copolymers of polyacrylate such as poly-n-stearyl methacrylate, or poly-n-lauryl methacrylate, which is a crystalline high polymer resin with a low molecular weight (e.g. a copolymer of n-stearyl acrylate-ethyl methacrylate); a crystalline polymer having a long alkyl group in the side chain; and the like may be used. Among these, synthetic waxes are preferred, and ester waxes are more preferred because they ensure high dispersibility and charge stability. The above-described polymers may be used singly, or a combination of two or more polymers may be used.

The melting point of the wax is not particularly limited, and can be appropriately selected according to the purpose. The melting point preferably is within a range from 50° C. to 120° C., and more preferably is within a range from 60° C. to 90° C. When the melting point is 50° C. or higher, it is possible to suppress bad influence brought from the wax to the heat-resistant storage stability. When the melting point is 120° C. or lower, it is possible to effectively suppress an occurrence of a cold offset at the time of fixing at low temperature.

A melt viscosity of the wax, as a measured value at a temperature higher than the melting point of the wax by 20° C., preferably is within a range from 5 cps to 1,000 cps, and more preferably is within a range from 10 cps to 100 cps. When the melt viscosity is 5 cps or more, it is possible to prevent the releasability from being decreased. When the melt viscosity is 1,000 cps or less, effects of hot offset resistance and the low-temperature fixing property can be exhibited sufficiently.

The content of the wax in the resin particles is not particularly limited, and can be appropriately selected according to the purpose. The content preferably is within a range from 0% by mass to 40% by mass, and more preferably is within a range from 3% by mass to 30% by mass. If the wax content is 40% by mass or less, deterioration of toner flowability can be prevented.

### (External Additive)

Inorganic fine particles and polymeric fine particles can be used as the external additive.

Examples of the inorganic fine particles include silica, alumina, titanium oxide, barium titanate, magnesium titanate, calcium titanate, strontium titanate, zinc oxide, tin oxide, silica sand, clay, mica, silica stone, diatomaceous earth, chromium oxide, cerium oxide, bengara, antimony trioxide, magnesium oxide, zirconium oxide, barium sulfate, barium carbonate, calcium carbonate, silicon carbide, silicon nitride, and the like.

The average particle size of the primary particles of the inorganic fine particles is preferably 5 nm to 2 µm and more preferably 5 nm to 500 nm.

The specific surface area of the inorganic fine particles by the BET method is preferably 20 m²/g to 500 m²/g.

The content of the inorganic fine particles to be used is preferably 0.01% by mass to 5% by mass of the resin particles.

Examples of polymeric fine particles include polystyrene obtained by soap-free emulsion polymerization, suspension polymerization and dispersion polymerization, polycondensation systems such as methacrylate and acrylic ester copolymers, silicon, benzoguanamine and nylon, and polymer particles made of thermosetting resins. Such fluidizing agents can be surface-treated to increase hydrophobicity and prevent deterioration of flow and charging characteristics even under high humidity. For example, silane coupling agents, silylating agents, silane coupling agents with alkyl fluoride groups, organic titanate-based coupling agents, aluminum-based coupling agents, silicone oils, modified silicone oils and the like can be mentioned as preferred surface treatment agents.

### (Cleanability Improver)

The cleanability improvers are used to remove any post-transfer developer that remains on a photoconductor and a primary transfer medium.

Examples of the cleanability improvers include fatty acid metal salts such as zinc stearate, calcium stearate, stearic acid, and the like; polymer fine particles produced by soap-free emulsion polymerization such as polymethyl methacrylate fine particles, polystyrene fine particles, and the like. The polymer fine particles preferably have a relatively narrow particle size distribution, and those with a volume average particle size of 0.01 µm to 1 µm are preferably used.

### Method of Producing Resin Particles

A method of producing resin particles according to one embodiment will be described. The method of manufacturing resin particles according to one embodiment includes an oil phase preparation step, an aqueous phase preparation step, a phase transfer emulsification step, a desolvating step, an agglomerating step, and a fusing step, and further includes other steps such as a shelling step, a washing step, a drying step, an annealing step, and an external additive step as necessary. According to the method of producing resin particles according to one embodiment, the location of the isoindoline-based pigment in the resin particles according to one embodiment can be adjusted as described above.

### [Oil Phase Preparation Step]

In the method of producing resin particles according to one embodiment, an oil phase is first prepared by dissolving or dispersing a binder resin, coloring agent containing isoindoline backbone pigment, cross-lining component, wax, and the like in an organic solvent.

In the method of preparing the oil phase, the binder resin, the coloring agent containing isoindoline backbone pigment, the cross-linking component, the wax, and the like may be gradually added into the organic solvent with stirring to dissolve or disperse them. For dispersion, known dispersing machines such as bead mills and disk mills can be used.

Each raw material used in the oil phase preparation step may be those described in the above resin particles according to one embodiment. These may be used alone or in combination of two or more. For example, a charge controlling agent or the like may be added to the oil phase.

### (Organic Solvents)

Although the organic solvent is not particularly limited and can be appropriately selected according to the purpose, it is preferable to use a volatile solvent with a boiling point of less than 100° C. because the volatile solvent makes it easier to remove the organic solvent later. Examples of the organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, isopropyl alcohol, or the like. These can be used alone or in combination of two or more kinds. When the resin to be dissolved or dispersed in the organic solvent is a resin having a polyester skeleton, ester solvents such as methyl acetate, ethyl acetate, and butyl acetate or ketone solvents such as methyl ethyl ketone and methyl isobutyl ketone are preferably used because of their high solubility. Among these, methyl acetate, ethyl acetate, and methyl ethyl ketone are particularly preferred because of their high solvent removability.

### [Aqueous Phase Preparation Step]

In the aqueous phase preparation step, the aqueous phase (aqueous medium) is prepared.

The aqueous medium is not particularly limited and can be selected from the known ones as appropriate, for example, water, solvents miscible with water, or mixtures thereof.

Solvents that can be miscible with water are not particularly limited and can be selected from the known solvents, for example, alcohols, dimethylformamide, tetrahydrofuran, cellsorbs, lower ketones, esters, or the like.

Examples of alcohols include methanol, isopropanol, ethylene glycol, or the like.

Examples of lower ketones include acetone or methyl ethyl ketone.

Examples of the esters include ethyl acetate.

These may be used alone or in combination of two or more.

### (Phase Transfer Emulsification Step)

The oil phase obtained in the oil-phase preparation step is finely particulated.

After neutralizing the oil phase with an alkali such as sodium hydroxide or ammonia water, ion-exchanged water is added to the neutralized oil phase to obtain a colored particulate dispersion liquid by phase transformation emulsification, which converts the dispersion liquid from a water-in-oil type to an oil-in-water type.

The phase transfer emulsification is carried out with stirring.

As a stirring blade, there is no particular limitation, and a stirring blade can be selected appropriately according to the viscosity of the solution. Examples of stirring blade include low-viscosity stirring blades such as paddles, propellers, and the like; medium-viscosity stirring blades such as anchors, max blends, and the like; and high-viscosity stirring blades such as helical ribbons and the like. Among these, paddles and anchors are preferably used in that the volume average particle size of the dispersions (oil droplets) can be controlled within the above desirable range.

When the stirring blade is used, the conditions such as the number of revolutions, the stirring time, the stirring temperature, and the like are not particularly limited and can be appropriately selected according to the purpose.

The number of revolutions is not particularly limited and is preferably from 100 rpm to 1,000 rpm, and more preferably from 200 rpm to 600 rpm.

The stirring time and stirring temperature are not particularly limited and may be selected as appropriate according to the purpose.

A dispersing agent may also be used if necessary. The dispersing agent is not particularly limited and can be selected appropriately according to the purpose. Examples of dispersing agents include surfactants, poorly water-soluble inorganic compound dispersants, polymeric protective colloids, and the like. These may be used alone or in combination of two or more. Among these, surfactants are preferably used.

The surfactants are not particularly limited and can be selected appropriately according to the purpose. Examples of surfactants include anionic surfactants, cationic surfactants, nonionic surfactants, amphoteric surfactants, and the like.

The anionic surfactants are not particularly limited and can be selected appropriately according to the purpose. Examples of anionic surfactants include alkylbenzene sulfonates, α-olefin sulfonates, phosphates, and the like. Among these, those having a fluoroalkyl group are preferably used.

### [Desolvating Step]

In the desolvating step, the organic solvent is removed from the resulting fine particle dispersion.

To remove the organic solvent from the resulting fine particle dispersion, a method can be employed in which the entire system is stirred and the temperature of the entire system is gradually raised to completely evaporate the organic solvent in the droplets.

Alternatively, the resulting fine particle dispersion can be sprayed into a dry atmosphere with stirring to completely remove the organic solvent in the droplets. In addition, the fine particle dispersion may be reduced in pressure with stirring to evaporate and remove the organic solvent.

These measures may be used alone or in combination.

As the drying atmosphere in which a colored fine particle dispersion is sprayed, various air currents heated to a temperature above the boiling point of the highest boiling solvent used are generally used, including air, nitrogen, carbon dioxide gas, combustion gas, and other heated gases. Short-term treatment of spray dryers, belt dryers, rotary kilns, or the like provides sufficient target quality.

The colored fine particle dispersion liquid can be obtained by removing the organic solvent from the obtained fine particle dispersion in the above manner.

### [Agglomerating Step]

The resulting colored fine particle dispersion liquid is agglomerated with stirring until it reaches the desired particle diameter to obtain agglomerated particles.

Conventional methods can be used to cause agglomeration, such as adding an agglomerating agent or adjusting pH. When an agglomerating agent is added, the agglomerating agent may be added as is, but the agglomerating agent is preferably converted into an aqueous solution so that a localized increase in concentration is avoided. In addition, the agglomerating agent is preferably gradually added while observing the particle size.

The temperature of the dispersion liquid during agglomeration is preferably near the glass transition temperature Tg of the resin used. If the liquid temperature of the colored fine particle dispersion liquid is too low, agglomeration will not appreciably proceed, resulting in poor efficiency. If the liquid temperature of the colored fine particle dispersion liquid is too high, the agglomeration rate increases, coarse particles are generated, and the particle size distribution deteriorates.

When the particle size becomes a desired particle size, the agglomeration is stopped. Methods for stopping agglomeration include adding salts or chelating agents with low ionic valence, adjusting the pH, lowering the temperature of the dispersion liquid, and diluting the concentration by adding a large amount of aqueous medium.

The dispersion liquid of the colored agglomerated particles can be obtained by the above method.

In the agglomerating step, a wax may be added as a release agent. In such cases, a dispersion liquid in which the wax is dispersed in an aqueous media or the wax is mixed with the colored fine particle dispersion liquid is agglomerated, resulting in obtaining agglomerated particles that the wax or the crystalline resin is evenly dispersed.

### [Fusing Step]

In the fusing step, the resulting agglomerated particles are then fused by heat treatment to reduce irregularities, making the particles spherical. The fusion may be accomplished by heating the dispersion of the agglomerated particles while stirring the dispersion of the colored agglomerated particles. Preferably, the temperature of the liquid is around the temperature exceeding the glass transition temperature Tg of the resin being used.

### [Shelling Step]

Shelling step may be performed as needed. The spherically shaped particles obtained in the fusing step may be shelled to form a shell layer on the surface of the spherically shaped particles. As a method of forming the shell layer, for example, after spherically shaped particles of the desired particle size are produced in the fusing step, an amorphous resin is added and the agglomeration and fusing step is repeated to form a shell layer on the spherically shaped particles obtained in the fusing step.

### [Washing and Drying Steps]

In the washing and drying steps, only the colored resin particles are removed from the colored agglomerated particle dispersion liquid obtained by the above method, followed by washing and drying.

### (Washing)

Since the colored agglomerated particle dispersion liquid obtained by the above-described method contains a secondary material such as agglomerating agent in addition to the colored agglomerated particles, washing is performed in order to remove only the colored resin particles from the colored dispersion liquid.

Methods of washing the colored resin particles include a centrifugal separation method, a reduced-pressure filtration method, and a filter press method. The methods of washing the colored resin particles are not particularly limited in the present embodiment. A cake body of the colored resin particles can be obtained by either method. If the colored resin particles cannot be sufficiently washed in a single operation, the cake obtained can be dispersed in an aqueous solvent again to make a slurry, and the step of removing the colored resin particles by either of the above methods can be repeated. If the washing is performed by a reduced-pressure filtration or filter press method, an aqueous solvent may be used to penetrate the cake and wash away the secondary materials contained in the resin particles.

As the aqueous medium used for this washing, water or a mixture of water and an alcohol such as methanol or ethanol are used. Water is preferably used in view of reducing cost and environmental load caused by, for example, drainage treatment.

### (Drying)

Since the washed colored agglomerated particles contain a large amount of aqueous medium, the colored agglomerated particles only can be obtained by drying and removing the aqueous medium.

As the drying method, a dryer such as a spray dryer, a vacuum freeze dryer, a reduced-pressure dryer, a static dryer, a mobile dryer, a fluidized dryer, a rotary dryer, a stirred dryer, or the like, can be used.

The dried colored resin particles are preferably dried until the final water content is less than 1%. If the colored resin particles after drying are agglomerated and impractical for use, the agglomerated particles may be pulverized using a device such as a jet mill, a Henschel mixer, a super mixer, a coffee mill, an Oster blender, or a hood processor to break up the agglomerated particles.

### [Annealing Step]

When crystalline resin is added, the crystalline resin and the amorphous resin are phase separated by annealing after drying, thereby improving fixing property. Specifically, the product should be stored at a temperature around Tg for at least 10 hours.

### [External Additive Step]

Other components such as an external additive agent, a cleanability improver, and the like may be added to the resulting resin particles so as to provide fluidity, chargeability, cleaning property, or the like.

Suitable methods may include, for example, applying an impact to the mixture using blades rotating at a high speed, throwing the mixture into a high-speed airflow to accelerate the mixture, and causing the particles to collide with each other or causing the particles to collide with an impact plate, and the like.

A device to be used for applying the mechanical impact to the mixture can be appropriately selected according to the purpose. For the device, angmill (by Hosokawa micron corporation), a device obtained by modifying I-type mill (by Nippon Pneumatic Mfg. Co., Ltd.) to reduce a pulverizing air pressure, a hybridization system (by Nara Machinery Co., Ltd.), Kryptron (Registered Trademark) (by Kawasaki Heavy Industries, Ltd.), automatic mortar, or the like, may be used.

As described above, by carrying out the oil phase preparation step, the aqueous phase preparation step, the phase transfer emulsification step, the desolvating step, the agglomerating step, and the fusing step, and further carrying out other steps such as the shelling step, the washing step, the drying step, the annealing step, and the external additive step as necessary, the resin particles of one embodiment can be obtained.

Thus, the resin particles according to one embodiment contain a base particle including a binder resin and a pigment having an isoindoline skeleton. When a longitudinal diameter of the base particle is L, an overlapped area where the cross-section of the base particle overlaps with a passage of circle C when a center of the circle C with a radius (L/10) moves along a contour of the cross-section of the base particle is defined as a surface layer of the resin particle. The pigment having isoindoline skeleton present on the surface layer of the base particle relative to an entire pigment having isoindoline skeleton present on the cross-section of the base particle in a cross-sectional image of the resin particle is less than 30%. A gel fraction of the base particle is 20% by mass or more. It is possible to suppress the pigment having an isoindoline skeleton from localizing on the surface of the base particles, and thus the lack of coloring of the resin particles of the present embodiment can be suppressed. In addition, variations in the resistance of the base particles due to the pigment can be suppress, thereby suppressing the reduction of charge stability. Therefore, the resin particles of one embodiment can exhibit high coloring and high charge stability.

The resin particle in one embodiment can use ester wax as a wax. Thus, the resin particles in one embodiment can enhance the dispersibility of wax in the resin particles by improving the compatibility with the binder resin. In addition, since the hydrophilic functional groups in the wax can be reduced, the environmental stability of charging can be improved.

The resin particles according to one embodiment contain an agglomerating agent, and the agglomerating agent can contain divalent or higher metal salts. As a result, the dispersibility of the isoindoline-based pigments can be further enhanced when the resin particles according to one embodiment are agglomerated by using the metal salts during the production of the resin particles, so that the uneven distribution of the isoindoline-based pigments on the surface of the base particles can be further suppressed. Therefore, the resin particles according to one embodiment can more reliably suppress the lack of coloring and further suppress the variation in the resistance value of the base particles. Therefore, the resin particles according to one embodiment can reliably exhibit high degree of coloring and have even higher charge stability.

The resin particles according to one embodiment contain a base particle including a binder resin and a pigment having an isoindoline skeleton. When a longitudinal diameter of the base particle is L, an overlapped area where the cross-section of the base particle overlaps with a passage of circle C when a center of the circle C with a radius (L/10) moves along a contour of the cross-section of the base particle is defined as a surface layer of the resin particle. The pigment having isoindoline skeleton present on the surface layer of the base particle relative to an entire pigment having isoindoline skeleton present on the cross-section of the base particle in a cross-sectional image of the resin particle is less than 25%. A gel fraction of the base particle is 25% by mass or more. It is possible to suppress the pigment having an isoindoline skeleton from localizing on the surface of the base particles, the lack of coloring of the resin particles of the present embodiment can be suppressed. In addition, variations in the resistance of the base particles due to the pigment can be further suppressed, thereby suppressing the reduction of charge stability. Therefore, the resin particles of one embodiment can exhibit higher coloring and higher charge stability.

Since the resin particles in one embodiment have the above characteristics, the resin particles can be effectively used as materials for image formation such as toner, developer, toner housing unit, and image forming apparatus.

### Toner

The toner according to one embodiment contains the resin particles according to one embodiment and may be formed from the resin particles of one embodiment.

By using the resin particles according to one embodiment for toner, it is possible to provide high-quality images with high degree of coloring and excellent charge stability.

### Developer

The developer of one embodiment includes the toner of one embodiment and may include other components, such as carriers, which are selected as appropriate, as needed. As a result, the developer with excellent coloring, transferability, chargeability, and the like can be provided, stably forming high-quality images.

The developer may be a single-component developer or a two-component developer. In the case where the developer is used for a high-speed printer, or the like, corresponding to the recent enhancement in the information processing speed, from a point of enhancing the service life of the printer, the two-component developer is preferably used.

When the toner according to one embodiment is used as a single-component developer, the toner having excellent coloring, transferability, charge stability, and the like can be provided, obtaining high-quality images.

If the developer of one embodiment is used in the two-component developer, it can be mixed with a carrier as a developer. If the toner of one embodiment is used in the two-component developer, the toner having excellent coloring, transferability, charge stability, and the like can be provided, obtaining high-quality images.

The content of the carrier in the two-component developer can be appropriately determined according to the purpose. The content preferably is within a range from 90 parts by mass to 98 parts by mass, and more preferably is within a range from 93 parts by mass to 97 parts by mass relative to 100 parts by mass of the two-component developer.

The developer according to the embodiment of the present application can preferably be used to form images using the conventional electrophotography, such as a magnetic single-component development method, a nonmagnetic single-component development method, or a two-component development method.

### [Carrier]

The carrier is not particularly limited and can be appropriately selected according to the purpose, but the carrier preferably has a core material and a resin layer (coating layer) covering the core material.

### (Core Materials)

The material of core is not particularly limited, and can be appropriately selected according to the purpose. Suitable materials of the core may include, for example, manganese-strontium based materials with a magnetization that is within a range from 50 emu/g to 90 emu/g and manganese-magnesium based materials with magnetization that is within a range from 50 emu/g to 90 emu/g. Moreover, to secure an image density, iron powder with a magnetization of 100 emu/g or greater, and a high magnetization material such as magnetite with magnetization that is within a range from 75 emu/g to 120 emu/g are preferably used. Moreover, a low magnetization material such as copper-zinc based material with magnetization that is within a range from 30 emu/g to 80 emu/g is preferably used because an impact of the developer held in the form of a brush against the photoconductor can be reduced, and it is advantageous for improving the image quality. The above-described materials may be used singly, or a combination of two or more materials may be used.

The volume average particle diameter of the core is not particularly limited, and can be appropriately determined according to the purpose. The volume average particle diameter preferably is within a range from 10 µm to 150 µm, and more preferably is within a range from 40 µm to 100 µm. When the volume average particle diameter is 10 µm or more, it is possible to effectively suppress problems such as increases in the amount of fine powders in the carrier, decreases in the magnetization per individual particle, and scattering of the carriers. Meanwhile, when the volume average particle diameter is 150 µm or less, it is possible to effectively suppress problems such as decreases in the specific surface area, occurrence of scattering of the toner, and poor reproduction of solid image portion in a full-color image including a lot of solid image portions.

### (Resin Layer)

The materials of the resin layer are not particularly limited and can be selected appropriately from among known resins according to the purpose. Examples the material of the resin layer include amino-based resins, polyvinyl-based resins, polystyrene-based resins, polyhalogenated olefins, polyester-based resins, polycarbonate-based resins, polyethylene, polyvinyl fluoride, polyvinylidene fluoride, polytrifluoroethylene, polyhexafluoropropylene, copolymers of vinylidene fluoride and acrylic monomers, copolymers of vinylidene fluoride and vinyl fluoride, fluoroterpolymers such as copolymers of tetrafluoroethylene, vinylidene fluoride and monomers without fluoro groups, silicone resins, and the like. These may be used alone or in combination of two or more.

Amino-based resins are not particularly limited and can be selected as appropriate according to the purpose, for example, urea-formaldehyde resin, melamine resin, benzoguanamine resin, urea resin, polyamide resin, epoxy resin, and the like.

Polyvinyl-based resin is not particularly limited and can be selected as appropriate according to the purpose, for example, acrylic resin, polymethyl methacrylate, polyacrylonitrile, polyvinyl acetate, polyvinyl alcohol, polyvinyl butyral, and the like.

Polystyrene-based resin is not particularly limited and can be selected as appropriate according to the purpose, for example, polystyrene, styrene-acrylic copolymer, and the like.

Polyhalogenated olefin is not particularly limited and can be selected as appropriate according to the purpose, for example, polyvinyl chloride, and the like.

The polyester-based resin is not particularly limited and can be selected appropriately according to the purpose, for example, polyethylene terephthalate, polybutylene terephthalate, and the like.

The resin layer may contain conductive powder, as needed. The conductive powder is not particularly limited and can be selected appropriately according to the purpose. Examples of the conductive powder include metal powder, carbon black, titanium oxide, tin oxide, zinc oxide, and the like. The average particle size of the conductive powder is preferably 1 µm or less. If the average particle size is 1 µm or less, the electrical resistance can be controlled.

The resin layer can be formed by preparing a coating solution by dissolving silicone resin or the like in a solvent, applying the coating solution to the surface of the core material using a known coating method, drying the coating solution, and then baking.

The coating method is not particularly limited and can be selected as appropriate according to the purpose, for example, a dip coating method, a spray method, a brush coating method, or the like can be used.

The solvent is not particularly limited and can be selected as appropriate according to the purpose, for example, toluene, xylene, methyl ethyl ketone, methyl isobutyl ketone, butyl acetate cellosolve, and the like.

The baking method may be an external heating method or an internal heating method. Examples of baking methods include a method using a fixed electric furnace, a fluidized electric furnace, a rotary electric furnace, a burner furnace, and microwaves.

The content of the resin layer in the carrier is not particularly limited and can be selected as appropriate according to the purpose. The content is preferably in a range from 0.01% by mass to 5.0% by mass. If the content of the resin layer is 0.01% by mass or more, a uniform resin layer can be formed on the surface of the core material. If the content is 5.0% by mass or less, the thickness of the resin layer is suppressed, so that fusion between carriers is suppressed and uniformity of carriers can be maintained.

### Developer Housing Container

A developer housing container according to one embodiment stores the developer of one embodiment. The developer housing container is not particularly limited, and known containers can be appropriately selected for the intended purpose. The developer housing container has a container body and a cap.

In addition, although the size, shape, structure, material, and the like of the container body are not particularly limited, the shape is preferably cylindrical and the like. The shape is particularly preferable that the inner circumference has spiral-shaped irregularities, and that by rotating it, the content, developer, can migrate to the outlet side, and that some or all of the spiral-shaped irregularities have a bellows function. Furthermore, the material is not particularly limited, but the material is preferable to have good dimensional accuracy, for example, resin materials such as polyester resin, polyethylene resin, polypropylene resin, polystyrene resin, polyvinyl chloride resin, polyacrylic acid, polycarbonate resin, ABS resin, polyacetal resin, and the like.

The developer housing container is easy to store, transport, and so on, and is excellent in handling. Therefore, the developer housing container can be detachably attached to an image forming apparatus, process cartridge, and the like, described later, and used for replenishing the developer.

### Toner Housing Unit

A toner housing unit according to the embodiment of the present application can store the toner of the embodiment of the present application. The toner housing unit according to the embodiment of the present application includes: a unit having a function of housing a toner; and a toner housed in the unit. Examples of the toner housing unit (unit with the toner housed therein) include, for example, a toner housing container, a developing unit, and a process cartridge.

The toner housing container refers to a container that stores a toner.

The developing unit refers to a unit that stores a toner and has a developing unit.

A process cartridge is one that includes at least an electrostatic latent image bearer and a developing device that are integrated, houses a toner, and is detachably attached to the image forming apparatus. The process cartridge may further be equipped with at least one selected from a chargeability part, an exposure part, a cleaning part, and the like.

### (Process Cartridge)

The process cartridge according to one embodiment is molded detachably in various image forming apparatuses and has an electrostatic latent image carrier that carries an electrostatic latent image and a developing part that develops the electrostatic latent image carried on the electrostatic latent image carrier with the developer according to one embodiment to form a toner image, and may have other configurations as needed.

Since the electrostatic latent image carrier is similar to the electrostatic latent image carrier of the image forming apparatus described later, details are omitted.

The developing part has a developer housing container for housing the developer of one embodiment and a developer carrier for carrying and transporting the developer housed in the developer housing container. The developing part may further have a regulating member or the like to regulate the thickness of the developer to be carried.

The toner housing unit according to one embodiment houses the toner according to one embodiment, and the toner according to one embodiment exhibits a high degree of coloring and also has a high charge stability. The toner according to one embodiment can provide high-quality images. By mounting the toner housing unit according to one embodiment on an image forming apparatus and using the characteristics of the toner according to one embodiment to form an image, excellent coloring, transferability, and chargeability can be provided, and high-quality images can be formed.

### Image Forming Apparatus

The image forming apparatus according to one embodiment has an electrostatic latent image bearer, an electrostatic latent image forming part that forms an electrostatic latent image on the electrostatic latent image bearer, and a developing part that develops the electrostatic latent image formed on the electrostatic latent image bearer using the toner to form a toner image, and can have other configurations as needed.

The image forming apparatus according to one embodiment is more preferably equipped with a transferring part for transferring the toner image onto a recording medium and a fixing part for fixing the transferred image onto the surface of the recording medium, in addition to the electrostatic latent image bearer, the electrostatic latent image forming part, and the developing part described above.

The toner according to one embodiment is used in the developing part. Preferably, a toner image may be formed by using the developer containing the toner of one embodiment and, if necessary, other components such as carriers or the like.

### (Electrostatic Latent Image Bearer)

A material, a shape, a structure, a size, and the like of the electrostatic latent image bearer (sometimes referred to as “electrophotographic photoconductor” or “photoconductor”) are not particularly limited, and can be appropriately selected from the conventional electrostatic latent image bearers. The materials of the electrostatic latent image bearer include, for example, inorganic photoconductors such as amorphous silicon, selenium, an and the like; organic photoconductors (OPC) such as polysilane, phthalo polymethine, and the like. Among them, amorphous silicon is preferably used from the viewpoint of longevity, and organic photoconductor (OPC) is preferably used from the viewpoint of obtaining more high-resolution images.

As the amorphous silicon photoconductor, for example, a photoconductor having a photoconductive layer made of a-Si can be used by heating a support to 50° C. to 400° C. and forming a film on the support by vacuum deposition method, sputtering method, ion plating method, thermal Chemical vapor deposition (CVD) method, photo CVD method, plasma CVD method, or the like. Among these, the plasma CVD method, in which source gas is decomposed by direct current or radio frequency or microwave glow discharge to form a deposited a-Si film on the support, is preferably used.

The shape of the electrostatic latent image bearer is not particularly limited and can be selected appropriately according to the purpose, but a cylindrical shape is preferably used. The outer diameter of the cylindrical electrostatic latent image bearer is not particularly limited and can be selected appropriately according to the purpose. The outer diameter of the cylindrical electrostatic latent image bearer is preferably in a range from 3 mm to 100 mm, more preferably in a range from 5 mm to 50 mm, and particularly preferably 10 mm to 30 mm.

The linear velocity of the electrostatic latent image carrier is preferably 300 mm/s or more.

### (Electrostatic Latent Image Forming Part)

The electrostatic latent image forming part is not particularly limited as long as the electrostatic latent image forming part is a device for forming an electrostatic latent image on the electrostatic latent image bearer, and can be selected appropriately according to the purpose. The electrostatic latent image forming part is provided with, for example, a charging member (charger) that uniformly charges the surface of the electrostatic latent image bearer and an exposure member (exposure device) that exposes the surface of the electrostatic latent image bearer in an image-like manner.

Chargers are not particularly limited and can be appropriately selected according to the purpose. Examples of chargers include contact chargers equipped with conductive or semiconducting rolls, brushes, films, rubber blades, and the like; and non-contact chargers such as corotrons, scorotrons, and the like using corona discharge.

The shape of the chargers can be any shape such as a magnetic brush, a fur brush, and the like, in addition to a roller and can be selected according to the specifications and shape of the image forming apparatus.

The charger is preferably arranged in contact or non-contact with the electrostatic latent image bearer, and charges the surface of the electrostatic latent image bearer by applying a superimposed direct current and alternating current voltage. The charger is preferably a charging roller arranged in close proximity to the electrostatic latent image bearer in a non-contact manner via a gap tape and charges the surface of the electrostatic latent image bearer by superimposing a direct current and an alternating current voltage on the charging roller.

Although the charger is not limited to a contact type charger. The charger is preferably a contact type charger that includes a charged member from a viewpoint of obtaining an image forming apparatus with reduced ozone generated from the charger.

The exposure device is not particularly limited as long as the exposure device can expose with an image to be formed onto the surface of the electrostatic latent image bearer charged by the charger, and can be appropriately selected according to the purpose. The exposure device includes, for example, various types of exposure devices such as a copying optical system, a rod lens array system, a laser optical system, a liquid crystal shutter optical system, and the like.

The light source used for the exposure device is not particularly limited and can be selected appropriately according to the purpose, for example, fluorescent lamps, tungsten lamps, halogen lamps, mercury lamps, sodium lamps, light emitting diodes (LED), semiconductor lasers (LD), electroluminescence (EL), and other luminous materials in general.

In addition, various filters such as a sharp cut filter, a bandpass filter, a near-infrared cut filter, a dichroic filter, an interference filter, and a light balancing filter, and the like can be used to emit only light in the desired wavelength range.

The exposure device may employ a light backplane system that exposes the image from the backside of the electrostatic latent image bearer.

### (Developing Part)

The developing part is not particularly limited and can be selected appropriately according to the purpose, if the visible image can be formed by developing the electrostatic latent image formed on the electrostatic latent image bearer. For example, the developing part can suitably be equipped with a developing device that contains toner and can apply toner to the electrostatic latent image in a contact or non-contact manner, and the developing device with a toner-containing container (unit with the toner housed therein) is preferably used.

The developing device be a monochromatic developing device or a multicolor developing device. As the developing device, for example, a developing device having a stirrer for charging toner by friction stirring and a magnetic field generating part fixed inside the developing device, and a developer carrier (for example, a magnet roller) capable of being rotated by carrying a developer containing toner on the surface is suitably used.

### (Transferring Part)

The transferring part is preferably configured to include a primary transferring part that transfers a visible image onto an intermediate transfer body to form a composite transfer image and a secondary transferring part that transfers the composite transfer image onto a recording medium. The intermediate transfer body is not particularly limited and can be selected from among known transfer bodies according to the purpose, and, for example, a transfer belt is preferably used.

The transferring part (primary transferring part and secondary transferring part) preferably has at least a transferring device that peels and charges the visible image formed on the electrostatic latent image bearer (photoconductor) onto the recording medium side. The transferring part may be one or two or more.

Examples of transferring devices include corona transfer devices by corona discharge, transfer belts, transfer rollers, pressure transfer rollers, adhesive transfer devices, and the like.

The recording medium is typically plain paper. The recording medium is not particularly limited as long as the recording medium is capable of transferring an unfixed image after developing an image, and any of the known recording media (recording paper) can be selected according to the purpose. PET bases for OHP and other materials can also be used.

### (Fixing Part)

The fixing part is not particularly limited, and can be appropriately selected according to the purpose. The fixing part is preferably a conventional heating and pressurizing part. Examples of the heating and pressurizing parts include a combination of a heating roller and a pressurizing roller, a combination of a heating roller, a pressuring roller, an endless belt, and the like.

The fixing part preferably has a heating body that includes a heating element, a film that contacts with the heating body, and a pressurizing member that heat-pressurizes with the heating body through the film. The fixing part is a heating and pressurizing part that can be heat-fixed by passing a recording medium in which an unfixed image is formed between the film and the pressurizing member.

Heating in the heating and pressurizing part is preferably from 80° C. to 200° C., in general.

The surface pressure in the heating and pressurizing part is not particularly limited and can be appropriately selected according to the purpose. The surface pressure is preferably in a range from 10 N/cm² to 80 N/cm².

In the present embodiment, for example, a known optical fixing device may be used along with or instead of the fixing part according to the purpose.

### (Others)

The image forming apparatus according to one embodiment may be provided with other parts, such as a static eliminating part, a recycling part, a control part, and the like.

### ((Static Eliminating Part))

The static eliminating part is not particularly limited, and only if a static elimination bias can be applied to the electrostatic latent image bearer, the static eliminating part can be suitably selected from known static eliminating devices, and for example, a static elimination lamp and the like can be suitably used.

### ((Cleaning Part))

The cleaning part can remove the toner remaining on the electrostatic latent image bearer, and the cleaning part can be selected appropriately from among known cleaners. Examples of the cleaning parts include a magnetic brush cleaner, an electrostatic brush cleaner, a magnetic roller cleaner, a blade cleaner, a brush cleaner, a web cleaner, and the like.

The image forming apparatus according to one embodiment can improve cleanability by having the cleaning part. That is, by controlling the adhesive force between the toners, the fluidity of the toner is maintained and the cleanability can be improved. In addition, by controlling the characteristics of the toner after deterioration, excellent cleaning quality can be maintained even under severe conditions such as long service life, and high temperature, and humidity. Furthermore, the external additive agent can be sufficiently freed from the toner on the photoconductor. Therefore, high cleanability can be achieved by forming a deposit layer (dam layer) of the external additive agent at the cleaning blade nip part.

### ((Recycling Part))

The recycling part is not particularly limited, but includes known transport means.

### ((Controlling Part))

The controlling part can control the movement of the above parts. As for the controlling part, if the movement of the above parts can be controlled, the controlling part is not particularly limited, and can be selected appropriately according to the purpose. For example, controlling devices such as sequencers and computers can be used.

The image forming apparatus of one embodiment can form images using the toner of one embodiment. Therefore, the toner having excellent coloring, transferability, and charge stability can be obtained, and high-quality images can be provided.

### Method of Forming Images

The method of forming images according to one embodiment includes an electrostatic latent image forming step of forming an electrostatic latent image on an electrostatic latent image bearer and a developing step of developing the electrostatic latent image using the toner to form a toner image, and may include other steps as needed. The method of forming images can be suitably performed by the image forming apparatus, the electrostatic latent image forming step can be suitably performed by the electrostatic latent image forming part, the developing step can be suitably performed by the developing part, and the other steps can be suitably performed by the other parts.

In addition, the method of forming images according to one embodiment more preferably includes a transferring step of transferring the toner image onto a recording medium and a fixing step of fixing the transferred image onto the surface of the recording medium, in addition to the above electrostatic latent image forming step and developing step.

In the developing step, the toner according to one embodiment is used. Preferably, a toner image may be formed by using a developer containing the toner of one embodiment and, if necessary, other components such as carriers.

The electrostatic latent image forming step is a step of forming an electrostatic latent image on an electrostatic latent image bearer and includes a charging step of charging the surface of the electrostatic latent image bearer and an exposure step of exposing the surface of the charged electrostatic latent image bearer to form an electrostatic latent image. Chargeability can be performed, for example, by applying a voltage to the surface of the electrostatic latent image bearer using a charger. Exposure can be performed, for example, by image-like exposure of the surface of the electrostatic latent image bearer using the exposure device. The formation of the electrostatic latent image can be performed by, for example, uniformly charging the surface of the electrostatic latent image bearer, followed by exposing as image-like exposure by the electrostatic latent image forming part.

The developing step is a step of forming a visible image by sequentially developing an electrostatic latent image with a multi-color toner. The formation of the visible image can be carried out, for example, by developing the electrostatic latent image using the toner by the developing device.

In the developing device, for example, the toner and the carrier are mixed and stirred, and the toner is charged by friction at that time, and is held on the surface of the rotating magnet roller in the form of brush. The magnet roller is located near the electrostatic latent image bearer (photoconductor), a part of the toner constituting the magnetic brush formed on the surface of the magnet roller moves to the surface of the electrostatic latent image bearer (photoconductor) by the electric attraction force. As a result, the electrostatic latent image is developed by the toner to form a visible image by the toner on the surface of the electrostatic latent image bearer (photoconductor).

The transferring step is the step of transferring a visible image onto a recording medium. The transferring step is preferably performed using an intermediate transfer body, and after primary transfer of the visible image onto the intermediate transfer body, a secondary transfer of the visible image onto the recording medium is performed.

The transferring step is more preferably performed using two or more toners, preferably full color toners, and includes a first transferring step in which the visible image is transferred onto the intermediate transfer body to form a composite transfer image, and a second transferring step in which the composite transfer image is transferred onto the recording medium. If the image to be secondarily transferred onto the recording medium is a color image consisting of toners of multiple colors, the transferring step may use an intermediate transfer medium to form an image on the intermediate transfer medium by sequentially overlaying toners of each color on the intermediate transfer medium, and then transfer the image on the intermediate transfer medium by the intermediate transfer medium to the recording medium in a batch for secondary transfer.

Transfer can be performed, for example, by charging the electrostatic latent image bearer (photoconductor) with a transfer charger for the visible image by a transferring part.

The fixing step is a step of fixing the visible image transferred onto the recording medium by using a fixing device, and may be performed for each color developer every time the image is transferred onto the recording medium, or simultaneously for each color developer in a laminated state.

The method of forming images according to one embodiment may further include other steps selected as appropriate, such as a static elimination step, a cleaning step, a recycling step, and the like.

The static elimination step is a step of applying a static elimination bias to the electrostatic latent image bearer to eliminate static electricity, and can be preferably performed by the static eliminating part.

The cleaning step is a step of removing the toner remaining on the electrostatic latent image bearer, and can be performed more favorably by the cleaning part.

The recycling step is a step of having the developing part recycle the toner removed by the cleaning step, and can be performed more favorably by the recycling part.

Since the method of forming images according to one embodiment can perform image formation using the toner according to one embodiment, the toner having excellent coloring, transferability, and charge stability can be obtained, and high-quality images can be provided.

### [One Embodiment of Image Forming Apparatus]

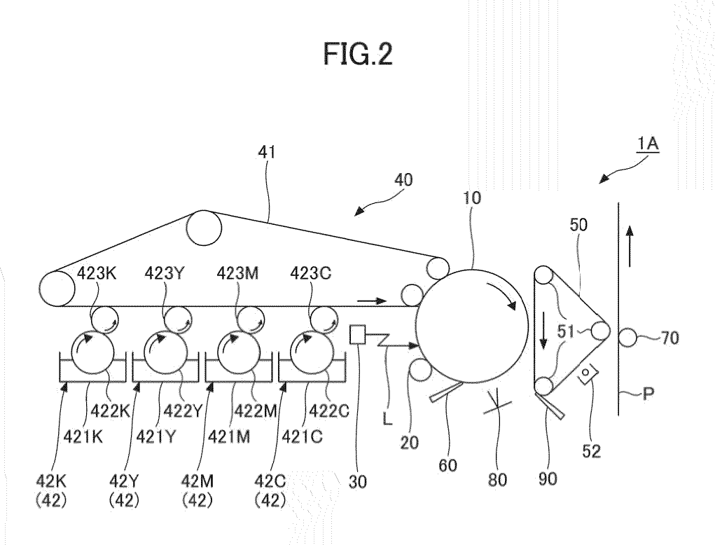

Next, one embodiment of the image forming apparatus according to one embodiment will be described with reference to FIG. 2. FIG. 2 is a schematic configuration diagram illustrating an example of an image forming apparatus according to an embodiment. As illustrated in FIG. 2, an image forming apparatus 1A is equipped with a photoconductor drum 10 which is an electrostatic latent image bearer, a charging roller 20 which is an charging part, an exposure device 30 which is an exposing part, a developing device 40 which is a developing part, an intermediate transfer body (intermediate transfer belt) 50, a cleaning device 60 which is a cleaning part, a transfer roller 70 which is a transferring part, a static elimination lamp 80 which is a static eliminating part, and an intermediate transfer body cleaning device 90.

The intermediate transfer body 50 is an endless belt stretched by three rollers 51 placed inside and designed to be movable in the direction, shown by arrow, by three rollers 51. Some of the three rollers 51 also function as transfer bias rollers capable of applying a predetermined transfer bias (primary transfer bias) to the intermediate transfer body 50. In the vicinity of the intermediate transfer body 50, the intermediate transfer body cleaning device 90 is placed. In the vicinity of the intermediate transfer body 50, the transfer roller 70 is placed opposite to the intermediate transfer body 50, and the transfer bias (secondary transfer bias) can be applied to transfer (secondary transfer) the developed image (toner image) to transfer (secondary transfer) a transfer paper P as a recording medium. Around the intermediate transfer body 50, a corona charger 52 for applying an electric charge to the toner image on the intermediate transfer body 50 is placed between a contact part between the photoconductor drum 10 and the intermediate transfer body 50 and the contact part between the intermediate transfer body 50 and the transfer paper P in the rotational direction of the intermediate transfer body 50.

The developing device 40 is configured by a developing belt 41 as a developer carrier and a developing unit 42 attached to the periphery of the developing belt 41.

The developing belt 41 is an endless belt stretched by a plurality of belt rollers and can be moved in the direction shown by the arrow in the figure. Furthermore, a part of the developing belt 41 is in contact with the photoconductor drum 10.

The developing unit 42 is configured by a black (Bk) developing unit 42K, a yellow (Y) developing unit 42Y, a magenta (M) developing unit 42M, and a cyan (C) developing unit 42C.

The black developing unit 42K includes a developer housing part 421K, a developer supply roller 422K, and a developing roller (developer carrier) 423K. The yellow developing unit 42Y includes a developer housing part 421Y, a developing supply roller 422Y, and a developing roller 423Y. The magenta developing unit 42M includes a developer housing part 421M, a developer supply roller 422M, and a developing roller 423M. The cyan developing unit 42C includes a developer housing part 421C, a developer supply roller 422C, and a developing roller 423C.

Next, a method of forming an image using the image forming apparatus 1A will be described. First, the surface of the photoconductor drum 10 is uniformly charged using the charging roller 20, and then expose an exposure light L to the photoconductor drum 10 using the exposure device 30 to form an electrostatic latent image. Then, the electrostatic latent image formed on the photoconductor drum 10 is developed with the toner supplied from the developing device 40 to form a toner image. Furthermore, the toner image formed on the photoconductor drum 10 is transferred (primary transfer) onto the intermediate transfer body 50 by the transfer bias applied from the roller 51, and then transferred (secondary transfer) onto the transfer paper P supplied by a paper feed part (not shown) by the transfer bias applied from the transfer roller 70. On the other hand, the photoconductor drum 10, on which the toner image is transferred to the intermediate transfer body 50, is eliminated by the static elimination lamp 80 after the toner remaining on the surface is removed by the cleaning device 60. The residual toner on the intermediate transfer body 50 after image transfer is removed by the intermediate transfer body cleaning device 90.

After the transferring step is completed, the transfer paper P is transported to a fixing unit, in which the toner image transferred above is fixed on the transfer paper P.

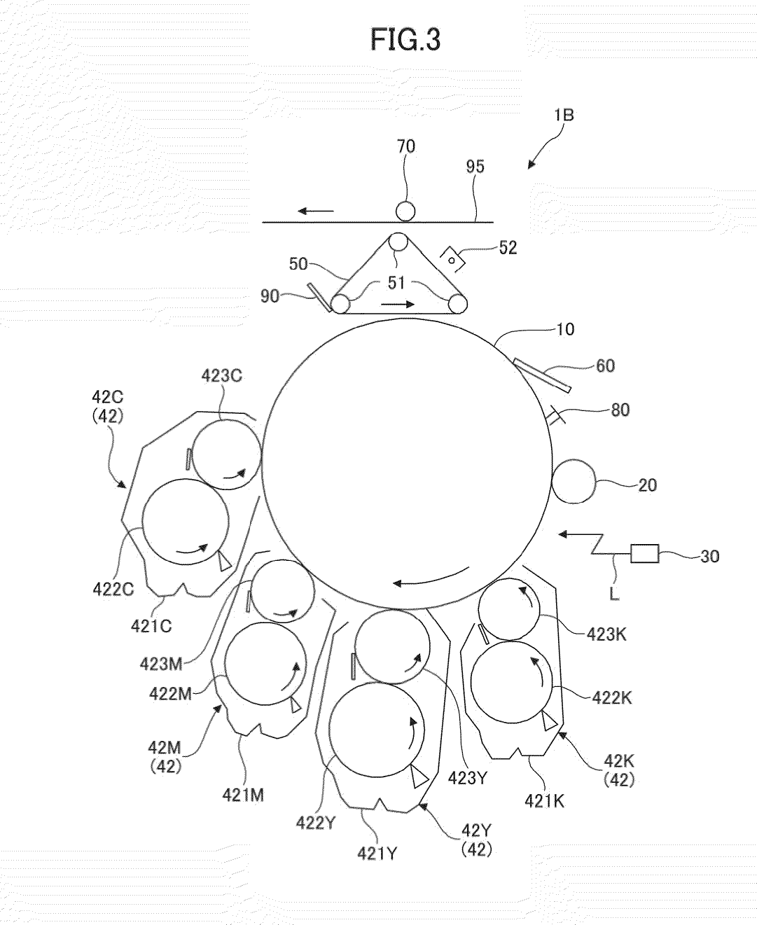

FIG. 3 is a schematic configuration diagram illustrating another example of an image forming apparatus according to one embodiment. As illustrated in FIG. 3, the image forming apparatus 1B has the same configuration as the image forming apparatus 1A in the image forming apparatus 1A illustrated in FIG. 2 except that the developing unit 42 (Black developing unit 42K, yellow developing unit 42Y, magenta developing unit 42M, and cyan developing unit 42C) is arranged directly facing each other around the photoconductor drum 10 without providing the developing belt 41.

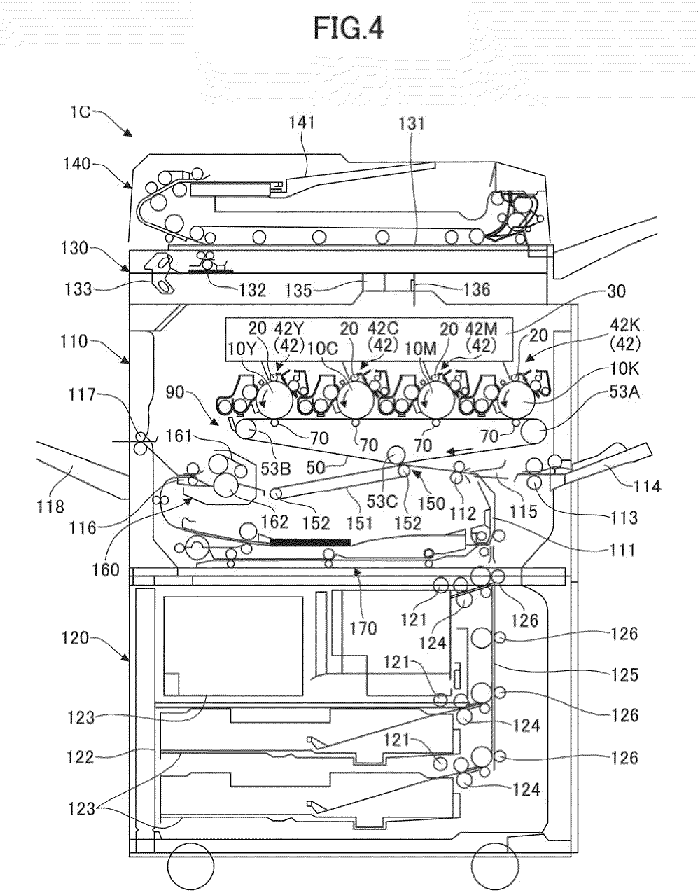

FIG. 4 is a schematic configuration diagram illustrating another example of an image forming apparatus according to one embodiment. As illustrated in FIG. 4, the image forming apparatus 1C is a tandem type color image forming apparatus and is equipped with a copying machine body 110, a paper feeding table 120, a scanner 130, an automatic document feeder (ADF) 140, a secondary transfer device 150, a fixing device 160 which is a fixing part, and a sheet reversing device 170.

An endless belt-shaped intermediate transfer body 50 is provided at the center of the copying machine body 110. The intermediate transfer body 50 is an endless belt stretched over three rollers 53A, 53B, and 53C and can move in the direction shown by the arrow in FIG. 4. In the vicinity of the roller 53B, the intermediate transfer body cleaning device 90 is placed to remove toner remaining on the intermediate transfer body 50 on which the toner image has been transferred to the recording paper. The developing unit 42 (Yellow (Y) developing unit 42Y, cyan (C) developing unit 42C, magenta (M) developing unit 42M, and black (Bk) developing unit 42K), which is a tandem type developing device, is placed opposite to and oppossed with the intermediate transfer body 50 stretched by the rollers 53A and 53B along the conveyance direction.

The exposure device 30 is placed in the vicinity of the developing unit 42. Further, the secondary transfer device 150 is placed on the side opposite to the side where the developing unit 42 of the intermediate transfer body 50 is placed. The secondary transfer device 150 is equipped with a secondary transfer belt 151. The secondary transfer belt 151 is an endless belt stretched over a pair of rollers 152, and the recording paper conveyed on the secondary transfer belt 151 and the intermediate transfer body 50 can contact between the roller 53C and the roller 152.

In addition, the fixing device 160 is placed in the vicinity of the secondary transfer belt 151. The fixing device 160 is equipped with a fixing belt 161, which is an endless belt stretched over a pair of rollers, and a pressure roller 162, which is placed and pressed against the fixing belt 161.

In the vicinity of the secondary transfer belt 151 and the fixing device 160, a sheet reversing device 170 is placed to reverse the recording paper when an image is formed on both sides of the recording paper.

Next, a method of forming a full-color image using an image forming apparatus 1C will be described. First, a color document is set on a document stand 141 of the automatic document feeder (ADF) 140, or, the ADF 140 is opened, the color document is set on an exposure glass 131 of the scanner 130, and the ADF 140 is closed.

In a case where a color document is set in the automatic document feeder 140 and a start switch (not shown) is pressed, and the color document is transported and moved to the exposure glass 131 and moved onto the exposure glass. Then, the scanner 130 is driven, and a first running body 132 and a second running body 133 equipped with light sources are driven. On the other hand, when a document is set on the exposure glass 131, the scanner 130 is driven to run the first running body 132 and the second running body 133 equipped with the light sources. At this time, the color document (color image) is read and black, yellow, magenta, and cyan image information is obtained by reflecting the light from the document surface emitted from the first running body 132 by the mirror on the second running body 133 and then receiving the light at a reading sensor 136 through an imaging lens 135.

The image information of each color is transmitted to each color developing unit (yellow developing unit 42Y, cyan developing unit 42C, magenta developing unit 42M, and black developing unit 42K) to form a toner image of each color.

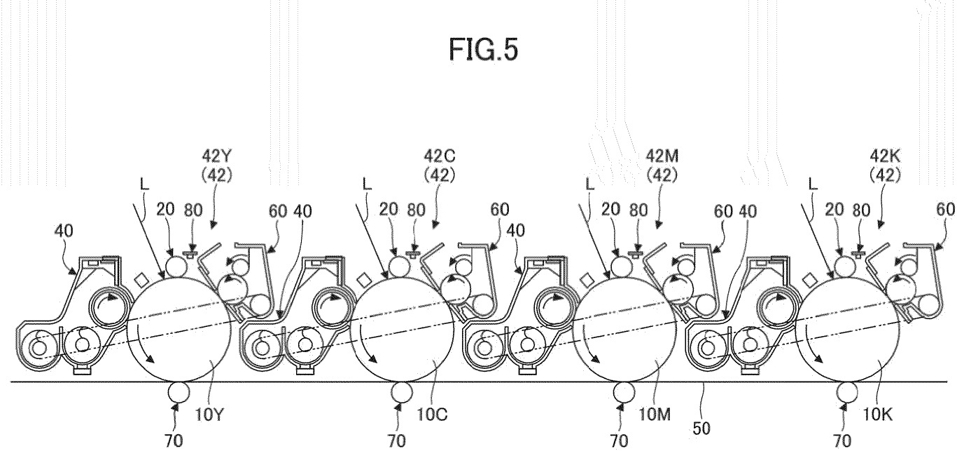

FIG. 5 is a partially enlarged view of the image forming apparatus of FIG. 4. As illustrated in FIG. 5, each developing unit (yellow developing unit 42Y, cyan developing unit 42C, magenta developing unit 42M, and black developing unit 42K) is equipped with a photoconductor drum 10 (photoconductor drum for black 10K, photoconductor drum for yellow 10Y, photoconductor drum for magenta 10M, and photoconductor drum for cyan 10C); a charging roller 20 which is a charging part for uniformly charging the photoconductor drum 10; the exposure device 30 which exposes an exposure light L on the photoconductor drum 10 based on image information of each color and forms an electrostatic latent image of each color on the photoconductor drum 10; the developing device 40 which is a developing part for developing an electrostatic latent image with a developer of each color and forming a toner image of each color; a transfer charger 62 for transferring a toner image onto the intermediate transfer body 50; the cleaning device 60; and the static elimination lamp 80.

Toner images of each color formed in each color developing unit (yellow developing unit 42Y, cyan developing unit 42C, magenta developing unit 42M, and black developing unit 42K) are sequentially transferred (primary transfer) onto the intermediate transfer body 50 that is stretched and moved by the rollers 53A, 53B, and 53C. Then, the toner images of each color are superimposed on the intermediate transfer body 50 to form a composite color image (color transfer image).

On the other hand, in the paper feed table 120, one of the paper feed rollers 121 is selectively rotated to feed the recording paper from one of the paper feed cassettes 123 provided in a paper bank 122 in multiple stages. The recording paper is separated one by one by separation rollers 124 and delivered to a paper feed path 125, conveyed by conveyance rollers 126, guided to a paper feed path 111 in a copying machine body 110, and stopped by abutting against a pair of resist roller 112. Alternatively, a manual feed roller 113 is rotated to feed out the recording paper on a manual feed tray 114, the paper is separated one by one by the manual feed roller 113, guided to a manual feed path 115, and stopped by abutting against the resist roller 112.

The resist roller 112 is generally used grounded, but may be used with a bias applied to remove paper dust from the recording paper.

Then, the resist roller 112 is rotated in timing with the composite color image (color transfer image) formed on the intermediate transfer body 50, the recording paper is sent out between the intermediate transfer body 50 and the secondary transfer belt 151, and the composite color image (color transfer image) is transferred (secondary transfer) onto the recording paper. Toner remaining on the intermediate transfer body 50 onto which the composite color image (color transfer image) has been transferred is removed by the intermediate transfer body cleaning device 90.

After the recording paper onto which the composite color image (color transfer image) has been transferred is conveyed by the secondary transfer belt 151, the composite color image (color transfer image) is fixed on the recording paper by the fixing device 160.

Then, the transfer path of the recording paper is switched by a switching pawl 116, and the recording paper is discharged onto a paper discharge tray 118 by a discharge roller 117. Alternatively, the transfer path of the recording paper is switched by the switching pawl 116, inverted by the sheet reversing device 170, guided again by the secondary transfer belt 151, an image is formed on the back of the recording paper in the similar manner, and then the recording paper is discharged by the discharge roller 117 onto the paper discharge tray 118.

### [One Aspect of the Process Cartridge]

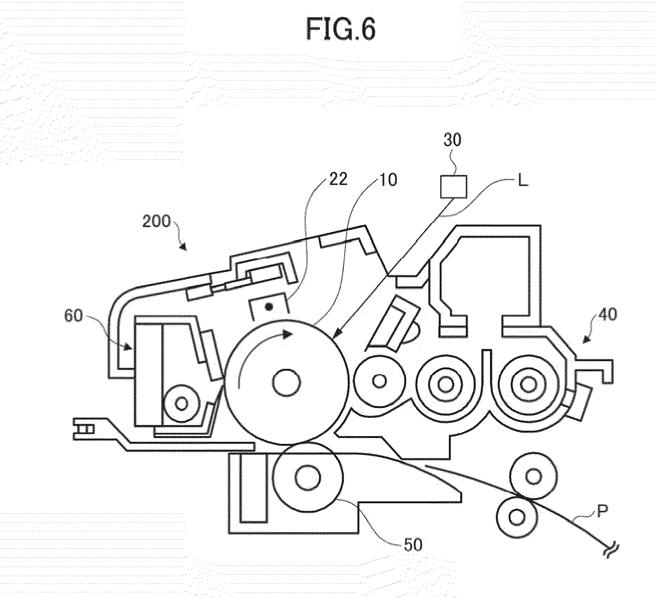

FIG. 6 illustrates an example of the process cartridge according to one embodiment. As illustrated in FIG. 6, an image forming apparatus process cartridge 200 includes the photoconductor drum 10, a corona charger 22 which is a charging part, the developing device 40, the cleaning device 60, and the transfer roller 70. In the figures, P indicates transfer paper and L indicates exposure light.

### EXAMPLES

Hereinafter, Examples and Comparative Examples are indicated to further illustrate the embodiments, but the embodiments are not limited by these Examples and Comparative Examples.

### Preparation of Polyester Resin

In a reaction vessel equipped with a cooling tube, an agitator, and a nitrogen introduction tube, 2 mol ethylene oxide adduct of bisphenol A/3 mol propylene oxide adduct of bisphenol A (molar ratio: 40/60) as a diol component, terephthalic acid/adipic acid (molar ratio: 85/15) as a dicarboxylic acid component and 3.5 mol% trimethylolpropane relative to the total monomer content were charged into the reaction vessel so that the molar ratio of hydroxyl group to carboxylic acid (OH/COOH) was to be 1.2. In addition, 1,000 ppm of tetrabutyl orthotitanate relative to the total monomer content was added as a condensation catalyst, and the reaction was carried out for 5 hours while heating up to 230° C. over 2 hours under nitrogen gas flow and distilling off the water produced. Then, the mixture was reacted under a reduced pressure of 5 mmHg to 15 mmHg for 4 hours, cooled to 180° C. 1.0 mol% of trimellitic anhydride with respect to the total monomer amount and 200 ppm of tetrabutyl orthotitanate with respect to the total monomer amount were added to the reaction vessel, and the mixture was reacted at 180° C. for 1 hour under normal pressure, and further reacted under a reduced pressure of 5 mmHg to 20 mmHg for 3 hours to obtain a polyester resin 1.

### Preparation of Coloring Agent Masterbatch 1

The polyester resin 1 and Pigment Yellow 185 (PY 185) were pre-mixed in a ratio of 1:1 using a Henschel mixer (FM20B, manufactured by Mitsui Miike Kako Co., Ltd.), and then melted and kneaded at a temperature of 130° C. using a biaxial kneader (PCM30, manufactured by Ikegai Co., Ltd.). The resulting mixture was rolled to a thickness of 2.7 mm by a roller, cooled to room temperature by a belt cooler, and coarsely ground to 200 µm to 300 µm by a hammer mill to obtain a coloring agent masterbatch 1.

### Preparation of Coloring Agent Masterbatch 2

The polyester resin 1 and Pigment Yellow 139 (PY139) were pre-mixed in a ratio of 1:1 using a Henschel mixer (FM20B, manufactured by Mitsui Miike Kako Co., Ltd.), and then melted and kneaded at a temperature of 130° C. using a biaxial kneader (PCM30, manufactured by Ikegai Co., Ltd.). The resulting mixture was rolled to a thickness of 2.7 mm by a roller, cooled to room temperature by a belt cooler, and coarsely ground to 200 µm to 300 µm by a hammer mill to obtain a coloring agent masterbatch 2.

### Preparation of WAX Dispersion 1

180 parts by mass (WE-11, Synthetic wax of plant-derived monomers, melting point 67° C., manufactured by NOF Corporation) of ester wax and 17 parts by mass (Neogen SC, sodium dodecylbenzene sulfonate, manufactured by Daiichi Kogyo Co., Ltd.) of anionic surfactant were added to 720 parts by mass of ion-exchanged water. The mixture was subjected to dispersion treatment with a homogenizer while being heated to 90° C. to obtain a WAX dispersion liquid 1.

### Preparation of WAX Dispersion 2

42 parts by mass of carnauba wax (RN-5, plant-derived wax, melting point 82° C., manufactured by Celarika Noda) and 420 parts by mass of ethyl acetate were charged into a container set with a stirring rod and a thermometer, and the mixture was heated to 80° C. while stirring, kept at 80° C. for 5 hours, and then cooled to 30° C. in 1 hour. Dispersion was performed under three passes by filling 80 vol.% of 0.5 mm diameter zirconia beads at a feed speed of 1 kg/hr and a disk peripheral speed of 6 m/s using a bead mill (Ultra Visco Mill, manufactured by Imex) to obtain a WAX dispersion liquid 2.

### Preparation of WAX Dispersion Liquid 3

30 parts by mass of octadecyl ether (melting point: 64° C.) as an ether wax was heat-dissolved in 250 parts by mass of ethyl acetate, followed by rapid cooling and precipitation with liquid nitrogen to obtain a WAX dispersion liquid 3.

### Preparation of WAX Dispersion Liquid 4

Paraffin wax was dispersed by heating 50 g of Fisher Tropsch wax (FT-0070, melting point: 72° C., manufactured by NIPPON SEIRO CO., LTD.), 5 g of cationic surfactant (SANIZOLE (Registered Trademark) B50, manufactured by Kao Corporation) and 200 g of ion exchange water to 95° C. using a homogenizer, and then dispersed by a pressure-discharge homogenizer to obtain a WAX dispersion liquid 4 containing release agent fine particles.

### Preparation of WAX Dispersion Liquid 5

50 parts by mass (HNP-9, hydrocarbon wax, melting point 75° C., SP value 8.8, manufactured by NIPPON SEIRO CO., LTD.) of paraffin wax and 450 parts by mass of ethyl acetate were charged into a container set with a stirring rod and a thermometer, and the temperature of the mixture was raised to 80° C. under stirring, kept at 80° C. for 5 hours, and then cooled to 30° C. in 1 hour. The mixture was then dispersed by using a bead mill (Ultra Visco Mill, manufactured by IMEX Co.,Ltd.) under the conditions of feeding speed of 1 kg/hr, disk circumferential speed of 6 m/s, filling 80 vol.% of 0.5 mm diameter zirconia beads, and three passes to obtain a WAX dispersion liquid 5.

### Preparation of Crystalline Polyester Resin

1,6-hexanediol and sebacic acid were charged into a 5 L four-neck flask equipped with a nitrogen introduction tube, a dehydrator tube, an agitator, and a thermocouple, so that the molar ratio of hydroxyl to carboxyl groups, OH/COOH, was to be 1.1. The prepared mixture was reacted with 500 ppm of titanium tetraisopropoxide with respect to the charged raw material while flowing water out, and the mixture was hearted to 235° C. and reacted for 1 hour. The mixture was then reacted under reduced pressure at 10 mmHg or less for 6 hours. Thereafter, the mixture was set to 185° C., and trimellitic anhydride was added to the mixture so that the molar ratio of the trimellitic anhydride to COOH group to be 0.053. The mixture was reacted for 2 hours while stirring to obtain a crystalline polyester resin.

A mixture of crystalline polyester resin (55 parts by mass), methyl ethyl ketone (40 parts by mass), and 2-propyl alcohol (5 parts by mass) was added to a four-neck flask. The mixture was then stirred while heating at the melting temperature of the crystalline polyester resin to dissolve the above crystalline polyester resin. A 28% by mass of aqueous ammonia solution was then added to the mixture to achieve a neutralization index of 400%. The neutralization index was calculated from the acid value of the crystalline polyester resin. Furthermore, ion exchange water (130 parts by mass) was gradually added to perform phase transfer emulsification followed by desolvation. Then, the concentration of solid content (the concentration of crystalline polyester resin) was adjusted to 25% by mass by adding ion exchange water to obtain a crystalline polyester resin dispersion liquid 1 such as a binder resin dispersion for toner.

### (Synthesis of Ketimine Compounds)

170 parts by mass of isophorone diamine and 75 parts by mass of methyl ethyl ketone were charged into a reaction vessel equipped with a stirring rod and a thermometer, and the reaction was carried out at 45° C. for 5 hours and a half to obtain a ketimine compound 1.

### Preparation of Resin Particles

### [Example 1]

### (Oil Phase Preparation, Phase Transfer Emulsification)

100 parts by mass of the polyester resin 1 and 10 parts by mass of the prepolymer 1 were charged into a four-neck flask, and 120 parts by mass of ethyl acetate was added to 10 parts by mass of the coloring agent masterbatch 1. These were mixed and stirred to dissolve and disperse. Then, 5 parts by mass of a 28% by mass of sodium hydroxide aqueous solution was added to the mixture while stirring to achieve a neutralization index of 200% to prepare an oil phase. The phase transfer emulsification was performed by gradually adding 340 parts by mass of ion-exchanged water. Then, the desolvation was performed to obtain a slurry 1.

### (Agglomerating Step and Fusing Step)

100 parts by mass of the slurry 1, 5.0 parts by mass of the crystalline polyester resin dispersion liquid 1, 5.0 parts by mass of the WAX dispersion liquid 1, and 300 parts by mass of ion-exchanged water were placed in a container and stirred for 1 minute. Next, 20 parts by mass of 5% aluminum sulfate solution was added dropwise to the solid content and stirred for another 5 minutes, and the mixture of the temperature was raised to 60° C. After that, when the particle size became 5.0 µm, 40 parts by mass of sodium chloride was added to the mixture to perform agglomeration, followed by heating the mixture at 70° C. while stirring. When a circularity reached to the desired circularity of 0.96, the mixture was cooled to obtain a resin particle dispersion liquid 1.

### (Annealing Step, Washing and Drying Steps)

The resin particle dispersion liquid 1 was stored at 45° C. for 10 hours, followed by being filtered under reduced pressure, and washed and dried as follows.

: 100 parts by mass of ion-exchanged water was added to the filtered cake, mixed with a TK homomixer (at 12,000 rpm for 10 minutes), and filtered.

: 900 parts by mass of ion-exchanged water was added to the filtered cake of (1), mixed with a TK homomixer by applying ultrasonic vibration (at 12,000 rpm for 30 minutes), and filtered under reduced pressure. This procedure was repeated so that the electrical conductivity of the re-slurry liquid was to be 10 µC/cm or less, and then filtered to obtain a filtered cake 1.

The filtered cake 1 was dried in a circulating air dryer at 45° C. for 72 hours and sieved with an eye-opening mesh of 75 µm to obtain colored resin particles 1.

### (External Additive)

2.5 parts by mass of inorganic fine particles (TS530, manufactured by Cabot) was added to 100 parts by mass of the colored resin particle 1, mixed with a Henschel mixer at 40 m/s for 10 minutes to obtain resin particles 1.

### [Example 2]

Example 2 was performed in the same manner as in Example 1, except that the solution used in the agglomerating step and fusing step in Example 1 was changed from the 5% aluminum sulfate solution to a 5% magnesium chloride solution to obtain resin particles 2.

### [Example 3]

Example 3 was performed in the same manner as in Example 1, except that the WAX dispersion liquid used in the agglomerating step and the fusing step was changed from the WAX dispersion liquid 1 to a WAX dispersion liquid 2 to obtain resin particles 3.

### [Example 4]

Example 4 was performed in the same manner as in Example 3, except that the solution used in the agglomerating step and the fusing step was changed from the 5% aluminum sulfate solution to a 5% magnesium chloride solution to obtain resin particles 4.

### [Example 5]

Example 5 was performed in the same manner as in Example 1, except that the WAX dispersion liquid used in the agglomerating step and the fusing step was changed from the WAX dispersion liquid 1 to a WAX dispersion liquid 3 to obtain resin particles 5.

### [Example 6]

Example 6 was performed in the same manner as in Example 5, except that the solution used in the agglomerating step and the fusing step was changed from the 5% aluminum sulfate solution to a 5% magnesium chloride solution to obtain resin particles 6.

### [Example 7]

Example 7 was performed in the same manner as in Example 1, except that the WAX dispersion liquid used in the agglomerating step and the fusing step was changed from the WAX dispersion liquid 1 to a WAX dispersion liquid 4 to obtain resin particles 7.

### [Comparative Example 1]

Comparative Example 1 was performed in the same manner as in Example 1, except that the WAX dispersion liquid used in the agglomerating step and the fusing step was changed from the WAX dispersion liquid 1 to a WAX dispersion liquid 5 to obtain resin particles 8 of Comparative Example 1.

### [Comparative Example 2]

Comparative Example 2 was performed in the same manner as in Example 1, except that the WAX dispersion liquid used in the agglomerating step and the fusing step was changed from the WAX dispersion liquid 1 to a WAX dispersion liquid 5, and also except that the solution used in the agglomerating step and the fusing step was changed from the 5% aluminum sulfate solution to a 5% magnesium chloride solution to obtain resin particles 9 of Comparative Example 2.

### [Comparative Example 3]

Comparative Example 3 was performed in the same manner as in Example 1, except that the coloring agent masterbatch 1 was changed to a coloring agent masterbatch 2 to obtain resin particles 10 of Comparative Example 3.

### Evaluation

For the resin particles of Examples 1 to 7 and Comparative Examples 1 to 3 prepared above, the amount of adhesion on the surface (surface of the resin particles) of the base particles of the pigment having an isoindoline skeleton, the gel fraction of the base particles, the degree of coloring of the resin particles, and the charge stability of the resin particles were measured and evaluated as described below. The evaluation results are shown in Table 1 below.

### [Amount of Adhesion of Pigment Having Isoindoline Skeleton on the Surface (Resin Particle Surface) of the Base Particles]

The amount of adhesion of the pigment having an isoindoline skeleton on the surface (the surface of resin particles) of the base particles in the cross-sectional image of the resin particles was measured as follows.

The cross-sectional image of the resin particles ware obtained. After embedding the resin particles in the epoxy resin, a sliced piece with a thickness of 0.1 to 0.2 µm was prepared with a microtome, and cross-sectional image was obtained by optical microscope, fluorescence microscope, SEM, TEM, and the like. The conditions are described below.
Microtome: Diamond knife (45° blade angle)
Optical microscope: Observed transmission image
Fluorescence microscope: Observed fluorescence image
TEM: Observed transmission image at 50 to 200 kV acceleration voltage
SEM: Observed at 0.8 to 2 kV acceleration voltage
Ion milling: Cross-sections created while cooling

After obtaining the cross-sectional image of the base particles, the amount of pigment having an isoindoline skeleton in the cross-section of the base particles is measured by the following procedure.

Step 1. Ten resin particles with an average volume particle size of Dv±1 µm are extracted.

Step 2. Using the Image-Pro Premier image analysis software, the contours of resin particles are extracted from the cross-sectional image of the resin particles. Step 3. The contours of coloring agents are also extracted from the contrast as in step 2.

Step 4. A center of circle C with a radius (L/10) is moved along the contour of a cross-section of the resin particle when the longitudinal diameter of base particle is L.

Step 5. The overlapped area where the cross-section of the resin particle overlaps with the passing area where the circle C passed is defined as a surface layer of the resin particle.

Step 6. The area of all cross-sections of pigments having an isoindoline skeleton present on the cross-sectional image of the base particle is calculated. Step 7. The Steps 2 to 6 are repeated to obtain an average value for ten base particles.

### [Measurement of Gel Fraction]

First, about 0.3 g of dried resin fine particles is prepared as a sample, and the sample was put into 30 g of an organic solvent and stirred for 60 minutes. Then, the mixture is centrifugated at a rotation speed of 10,000 rpm for 5 minutes, followed by removing the supernatant from which the solvent is extracted. Then, the undissolved substance in the organic solvent is dried in a vacuum dryer. The weight of dried substance is measured, and the gel fraction (% by mass) is calculated by the following equation. It should be noted that the organic solvent, for example, tetrahydrofuran or the like may be used. Gel fraction (% by mass) = (weight of the group of monodispersed resin particles undissolved in the organic solvent/weight of the group of monodispersed resin particles to be used for the sample) x 100

### [Degree of Coloring]

The degree of coloring of the resin particles 1 to 7 was measured and evaluated (determined) as follows.

### (Method of Measuring the Degree of Coloring)

Each two-component developer was developed on an aluminum substrate by cascade development to achieve a resin particle adhesion of 0.3 mg/cm², and then electrostatically transferred from the aluminum substrate to double-sided Tokubishi Art paper to produce images fixed at a fixing temperature of 180° C. by a belt fixer (Linear velocity 282 mm/sec, nip time 40.1 msec, nip pressure 37 N/cm²). For the above images, ID measurement was performed with a Model 938 (manufactured by X-Rite), and the degree of coloring was evaluated based on the following evaluation criteria. A color ID of 1.55 or higher was considered excellent (A), a color ID of 1.50 or higher and lower than 1.55 was considered good (B), a color ID of 1.45 or higher and lower than 1.50 was considered normal (C), and a color ID of lower than 1.45 was considered poor (D).

### -Evaluation Criteria-

A: The color ID is 1.55 or higher
B: The color ID is 1.50 or higher and lower than 1.55
C: The color ID is 1.45 or higher and lower than 1.50
D: The color ID is lower than 1.45

### [Charge Stability]

A commercial digital full-color printer (imagioNeo C455) was remodeled with developer loaded, and 300,000 running evaluations were performed on an image chart with 50% image area in monochromatic mode. The charge stability was evaluated based on the evaluation criteria by the amount of change in the charge amount of the carrier after this running.

The amount of change in the charge amount was as follows: the sample was prepared by dehumidifying it in an open system at an air temperature of 23° C. and a relative humidity of 50% (M/M environment) for more than 30 minutes, adding 6.000 g of initial carrier and 0.452 g of resin particles to a stainless steel container, sealing it, running it for 5 minutes on a scale of 150 using a shaker (YS-LD, manufactured by Yayoi), and tribocharging it by shaking it about 1,100 times. The sample was measured by the blow-off method by using Blow-off Charge Measurement Device (TB-200, manufactured by Toshiba Chemical Corporation) was designated as Q1. For the carrier obtained by removing the resin particles in the developer after running using the blow-off device, the amount of charge measured by the same method was designated as Q2. The amount of change in the charge amount was defined as the absolute value of the amount of charge Q1 minus the amount of charge Q2 (|Q1-Q2|).

### (Evaluation Criteria)

A: The change in charge amount is less than 10 µc/g.
B: The change in charge amount is 10 µc/g or more and less than 15 µc/g.
C: The change in charge amount is 15 µc/g or more and less than 20 µc/g.
D: The change in charge amount is 20 µc/g or more.

### [Overall Evaluation]

The overall evaluation was based on the following evaluation criteria. For those in which both the degree of coloring and charge stability were “A” were evaluated as “A”. For those in which the evaluation items of the degree of coloring and charge stability was “A” or “B” and the rest was “B”, were evaluated as “B”. For those in which at least one of the evaluation items of the degree of coloring and charge stability was “C” was evaluated as “C”. For those in which at least one evaluation item with at least one D in the degree of coloring and charge stability was evaluated as “D”.

### (Evaluation Criteria)

A: Excellent
B: Good
C: Slightly better than conventional
D: Not practical

The resin particles 1 to 7 used in the evaluation and the evaluation results of the resin particles 1 to 7 are shown in Table 1.

[TABLE 1]

| | Production conditions | | | Adhesive amount of pigment having isoindoline skeleton on the toner surface | Gel fraction of based particles [%] | Evaluation results | | |
|---|---|---|---|---|---|---|---|---|
| | Type of coloring agentm asterbatch (pigment) | Type of WAX dispersion liquid (Type of WAX) | Valence of agglomerating agent | | | Degree of coloring | Charge stability | overall evaluation |
| Example 1 | Coloring agentm asterbatch 1 (PY185) | WAX dispersion liquid 1 (ester) | trivalent | 8 | 26 | A | A | A |
| Example 2 | Coloring agentm asterbatch 1 (PY185) | WAX dispersion liquid 1 (ester) | divalent | 27 | 22 | B | B | B |
| Example 3 | Coloring agentm asterbatch 1 (PY185) | WAXd ispersion liquid 2 (carnauba wax) | trivalent | 24 | 24 | A | B | B |
| Example 4 | Coloring agentm asterbatch 1 (PY185) | WAX dispersion liquid 2 (carnauba wax) | divalent | 27 | 26 | B | A | B |
| Example 5 | Coloring agentm asterbatch 1 (PY185) | WAX dispersion liquid 3 (octadecyl ether) | trivalent | 23 | 26 | B | A | B |
| Example 6 | Coloring agentm asterbatch 1 (PY185) | WAX dispersion liquid 3 (octadecyl ether) | divalent | 16 | 26 | B | B | B |
| Example 7 | Coloring agentm asterbatch 1 (PY185) | WAX dispersion liquid 4 (Fisher Tropsch wax) | trivalent | 23 | 30 | B | B | B |
| Comparative Example 1 | Coloring agentm asterbatch 1 (PY185) | WAX dispersion liquid 5 (paraffin) | trivalent | 35 | 21 | C | D | D |
| Comparative Example 2 | Coloring agentm asterbatch 1 (PY185) | WAX dispersion liquid 5 (paraffin) | divalent | 25 | 18 | D | C | D |
| Com parative Example 3 | Coloring agentm asterbatch 2 (PY139) | WAX dispersion liquid 1 (ester) | divalent | 35 | 15 | D | D | D |

From Table 1, it was confirmed that both the degree of coloring and the charge stability of the resin particles in Examples 1 to 7 fulfilled the conditions for use, and these were evaluated as favorable. On the other hand, it was confirmed that the degree of coloring or the charge stability of the resin particles in Comparative Examples 1 to 3 did not fulfill the conditions for use, and these were evaluated as unfavorable.

Therefore, unlike the resin particles of Comparative Examples 1 to 3, in the resin particles of Examples 1 to 7, the pigment having an isoindoline skeleton present on the surface layer of the base particle relative to an entire pigment having an isoindoline skeleton present on the cross-section of the base particle in a cross-sectional image of the resin particle were 8% to 27%, and the gel fraction were 22% to 26%. As a result, excellent degree of coloring and charge stability were obtained. Therefore, the resin particles of Examples 1 to 7 can be provided as high-quality toners.

As described above, the above embodiment is presented as an example, and the present invention is not limited by the above embodiment. The above embodiment can be carried out in various other forms, and various combinations, omissions, replacements, modifications, and the like can be made without departing from the gist of the invention. These embodiments and their variations are included in the scope and abstract of the invention as well as in the equal scope of the invention described in specific embodiments.

The embodiment of the invention is, for example, as follows.

<1> Resin particles includes a base particle including a binder resin and a pigment having an isoindoline skeleton, wherein a longitudinal diameter of the base particle is L, an overlapped area where the cross-section of the base particle overlaps with a passage of circle C when a center of the circle C with a radius (L/10) moves along a contour of the cross-section of the base particle is defined as a surface layer of the resin particle, wherein the pigment having the isoindoline skeleton present on the surface layer of the base particle relative to an entire pigment having the isoindoline skeleton present on the cross-section of the base particle in a cross-sectional image of the resin particle is less than 30%, and wherein a gel fraction of the base particle is 20% by mass or more.

<2> The resin particles according to <1>, further comprising a wax, wherein the wax is an ester wax.

<3> The resin particles according to <1> or <2>, further includes an agglomerating agent, wherein the agglomerating agent contains a divalent or higher metal salt.

<4> The resin particles according to any one of <1> to <3>, wherein the pigment having the isoindoline skeleton present on the surface layer of the base particle relative to the entire pigment having the isoindoline skeleton present on the cross-section of the base particle in the cross-sectional image of the resin particle is less than 25%, and wherein the gel fraction of the base particle is 25% by mass or more.

<5> The resin particles according to any one of <1> to <4>, further includes a release agent.

<6> The resin particles according to any one of <1> to <5>, further includes an external additive agent.

<7> A toner is composed of the resin particles of any one of <1> to <6>.

<8> A developer contains the toner of <7> and a carrier.

<9> A toner housing unit contains the toner of <7>.

<10> An image forming apparatus includes an electrostatic latent image bearer; an electrostatic latent image forming part that forms an electrostatic latent image on the electrostatic latent image bearer; a developing part that develops the electrostatic latent image using a toner to form a visible image; a transferring part that transfers the visible image onto a recording medium; and a fixing part that fixes the transferred image onto the recording medium, wherein the toner is the toner of <7>.

<11> A method of forming images includes an electrostatic latent image forming step that forms an electrostatic latent image on an electrostatic latent image bearer; a developing step that develops the electrostatic latent image using a toner to form a visible image; a transferring step that transfers the visible image onto a recording medium; and a fixing step that fixes a transferred image onto the recording medium, wherein the toner is the toner of <7>.

What is claimed is:

1. Resin particles, comprising:
a base particle including a binder resin and a pigment having an isoindoline skeleton,
wherein a longitudinal diameter of the base particle is L, an overlapped area where the cross-section of the base particle overlaps with a passage of circle C when a center of the circle C with a radius (L/10) moves along a contour of the cross-section of the base particle is defined as a surface layer of the resin particle,
wherein the pigment having isoindoline skeleton present on the surface layer of the base particle relative to an entire pigment having isoindoline skeleton present on the cross-section of the base particle in a cross-sectional image of the resin particle is less than 30%, and
wherein a gel fraction of the base particle is 20% by mass or more.

2. The resin particles according to claim 1, further comprising a wax, wherein the wax is an ester wax.

3. The resin particles according to claim 1, further comprising an agglomerating agent, wherein the agglomerating agent contains a divalent or higher metal salt.

4. The resin particles according to claim 1,
wherein the pigment having isoindoline skeleton present on the surface layer of the base particle relative to the entire pigment having isoindoline skeleton present on the cross-section of the base particle in the cross-sectional image of the resin particle is less than 25%, and
wherein the gel fraction of the base particle is 25% by mass or more.

5. The resin particles according to claim 1, further comprising a release agent.

6. The resin particles according to claim 1, further comprising an external additive agent.

7. A toner, composed of the resin particles of claim 1.

8. A developer, containing the toner of claim 7 and a carrier.

9. A toner housing unit, containing the toner of claim 7.

10. An image forming apparatus, comprising:
an electrostatic latent image bearer;
an electrostatic latent image forming part that forms an electrostatic latent image on the electrostatic latent image bearer;
a developing part that develops the electrostatic latent image using a toner to form a visible image;
a transferring part that transfers the visible image onto a recording medium; and
a fixing part that fixes the transferred image onto the recording medium,
wherein the toner is the toner of claim 7.

11. A method of forming images, comprising:
forming an electrostatic latent image on an electrostatic latent image bearer;
developing the electrostatic latent image using a toner to form a visible image;
transferring the visible image onto a recording medium; and
fixing a transferred image onto the recording medium,
wherein the toner is the toner of claim 7.
